(19) United States
(12) Patent Application Publication
(10) Pub. No.: US 2026/0040366 A1
(43) Pub. Date: Feb. 5, 2026

(54) BEAM SELECTION TECHNIQUES FOR WIRELESS COMMUNICATIONS

(71) Applicant: QUALCOMM Incorporated, San Diego, CA (US)

(72) Inventors: Xiao Feng WANG, San Diego, CA (US); Changhwan PARK, San Diego, CA (US); Le LIU, San Jose, CA (US); Alberto RICO ALVARINO, San Diego, CA (US); Jae Ho RYU, San Diego, CA (US); Chiranjib SAHA, Lakeside, CA (US)

(21) Appl. No.: 19/267,298

(22) Filed: Jul. 11, 2025

Related U.S. Application Data
(60) Provisional application No. 63/678,410, filed on Aug. 1, 2024.

(51) Int. Cl. H04W 74/0833; H04W 64/00; H04W 84/06

(52) U.S. Cl. CPC H04W 74/0833; H04W 64/00; H04W 84/06

(57) ABSTRACT

Methods, systems, and devices for wireless communications are described that provide for synchronization signal block (SSB) transmissions in a non-terrestrial network (NTN) using a relatively wide beam and data communications via relatively narrow beams. A transmitting satellite in a NTN may transmit system information blocks that correlate SSB or reference signal transmissions to particular random access channel (RACH) resources. The SIBs may indicate RACH resources associated with different user equipment (UE) locations that correspond to narrow beams, or may indicate RACH resources associated with different CSI-RS resources. A particular narrow beam may be selected based on a location of the UE and a RACH resource that is associated with that location. In cases where a beam is a moving beam, and the location associated with the RACH resource may be based on a reference time point and an ephemeris of the transmitting satellite.

### CROSS REFERENCES

The present Application for Patent claims benefit of U.S. Provisional Patent Application No. 63/678,410 by WANG et al., entitled “BEAM SELECTION TECHNIQUES FOR WIRELESS COMMUNICATIONS,” filed Aug. 1, 2024, assigned to the assignee hereof, and expressly incorporated herein.

### FIELD OF TECHNOLOGY

The following relates to wireless communications, including beam selection techniques for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a set of reference locations for a set of synchronization signal block (SSBs) transmitted by a network entity, each SSB of the set of SSBs associated with one or more reference locations of the set of reference locations, and each reference location associated with a random access resource of a set of random access resources, selecting a first random access resource of the set of random access resources based on a first location of the UE corresponding to a first reference location and on one or more measured channel parameters of a first SSB associated with the first reference location, and transmitting a random access message using the first random access resource.

A UE for wireless communications is described. The UE may include one or more memories storing processor executable code, and one or more processors coupled with the one or more memories. The one or more processors may individually or collectively be operable to execute the code to cause the UE to receive a set of reference locations for a set of SSBs transmitted by a network entity, each SSB of the set of SSBs associated with one or more reference locations of the set of reference locations, and each reference location associated with a random access resource of a set of random access resources, select a first random access resource of the set of random access resources based on a first location of the UE corresponding to a first reference location and on one or more measured channel parameters of a first SSB associated with the first reference location, and transmit a random access message using the first random access resource.

Another UE for wireless communications is described. The UE may include means for receiving a set of reference locations for a set of SSBs transmitted by a network entity, each SSB of the set of SSBs associated with one or more reference locations of the set of reference locations, and each reference location associated with a random access resource of a set of random access resources, means for selecting a first random access resource of the set of random access resources based on a first location of the UE corresponding to a first reference location and on one or more measured channel parameters of a first SSB associated with the first reference location, and means for transmitting a random access message using the first random access resource.

A non-transitory computer-readable medium storing code for wireless communications is described. The code may include instructions executable by one or more processors to receive a set of reference locations for a set of SSBs transmitted by a network entity, each SSB of the set of SSBs associated with one or more reference locations of the set of reference locations, and each reference location associated with a random access resource of a set of random access resources, select a first random access resource of the set of random access resources based on a first location of the UE corresponding to a first reference location and on one or more measured channel parameters of a first SSB associated with the first reference location, and transmit a random access message using the first random access resource.

In some examples of the method, UEs, and non-transitory computer-readable medium described herein, receiving the set of reference locations may include operations, features, means, or instructions for receiving system information that indicates the set of reference locations and associated random access resources. In some examples of the method, UEs, and non-transitory computer-readable medium described herein, the one or more reference locations correspond to global navigation satellite system (GNSS) positions, and where each GNSS position may be associated with a transmit and receive beam that has a smaller coverage area than a SSB beam used to transmit a SSB associated with a reference location.

In some examples of the method, UEs, and non-transitory computer-readable medium described herein, each random access resource of the set of random access resources corresponds to a random access occasion, a set of random access sequences to be included in an associated random access message, or any combination thereof.

In some examples of the method, UEs, and non-transitory computer-readable medium described herein, the one or more SSBs of the set of SSBs are associated with transmit and receive beams having moving coverage areas and the method, apparatuses, and non-transitory computer-readable medium may include further operations, features, means, or instructions for determining that the first location of the UE corresponds to the first reference location based on a time instance associated with the first reference location and ephemeris information associated with the network entity. In some examples of the method, UEs, and non-transitory computer-readable medium described herein, the time instance associated with the first reference location may be explicitly indicated or pre-defined with reference to a reception time of a system information block that carries the time instance.

Some examples of the method, UEs, and non-transitory computer-readable medium described herein may further include operations, features, means, or instructions for transmitting a beam switch request that indicates a first beam for communications with the UE is to be switched to a second beam, where the first beam corresponds to a first narrow beam associated with the first location. Some examples of the method, UEs, and non-transitory computer-readable medium described herein may further include operations, features, means, or instructions for receiving configuration information that indicates a set of reference signal resources in which an index value of each reference signal resource is associated with a corresponding narrow beam, where the beam switch request indicates a second index value associated with the second beam. In some examples of the method, UEs, and non-transitory computer-readable medium described herein, the set of reference signal resources and associated index values may be received in one or more system information blocks.

In some examples of the method, UEs, and non-transitory computer-readable medium described herein, the beam switch request is transmitted based on one or more channel measurements associated with the second beam meeting a measurement threshold value for a configured quantity of measurements or for a configured time period. In some examples of the method, UEs, and non-transitory computer-readable medium described herein, the beam switch request includes an index value of a second reference location among the set of reference locations that is a nearest reference location to a current location of the UE.

Some examples of the method, UEs, and non-transitory computer-readable medium described herein may further include operations, features, means, or instructions for transmitting a beam switch request to switch from a first transmit and receive beam associated with the first location to a second transmit and receive beam associated with a second reference location of the set of reference locations, where the beam switch request may be transmitted in a medium access control (MAC) control element or may be a random access preamble using a second random access resource associated with the second reference location. In some examples of the method, UEs, and non-transitory computer-readable medium described herein, the beam switch request may be transmitted based on the a current location of the UE being closer to the second reference location. In some examples of the method, UEs, and non-transitory computer-readable medium described herein, the random access preamble may be configured by the network entity.

A method for wireless communications by a UE is described. The method may include receiving configuration information that indicates a set of reference signal resources and a random access resource associated with each reference signal resource of the set of reference signal resources, selecting a first random access resource based on one or more measured channel parameters of a first reference signal resource of the set of reference signal resources, and transmitting a random access message using the first random access resource.

A UE for wireless communications is described. The UE may include one or more memories storing processor executable code, and one or more processors coupled with the one or more memories. The one or more processors may individually or collectively be operable to execute the code to cause the UE to receive configuration information that indicates a set of reference signal resources and a random access resource associated with each reference signal resource of the set of reference signal resources, select a first random access resource based on one or more measured channel parameters of a first reference signal resource of the set of reference signal resources, and transmit a random access message using the first random access resource.

Another UE for wireless communications is described. The UE may include means for receiving configuration information that indicates a set of reference signal resources and a random access resource associated with each reference signal resource of the set of reference signal resources, means for selecting a first random access resource based on one or more measured channel parameters of a first reference signal resource of the set of reference signal resources, and means for transmitting a random access message using the first random access resource.

A non-transitory computer-readable medium storing code for wireless communications is described. The code may include instructions executable by one or more processors to receive configuration information that indicates a set of reference signal resources and a random access resource associated with each reference signal resource of the set of reference signal resources, select a first random access resource based on one or more measured channel parameters of a first reference signal resource of the set of reference signal resources, and transmit a random access message using the first random access resource.

In some examples of the method, UEs, and non-transitory computer-readable medium described herein, receiving the configuration information may include operations, features, means, or instructions for receiving, for each port of one or more reference signal resources of the set of reference signal resources, an associated random access resource.

In some examples of the method, UEs, and non-transitory computer-readable medium described herein, selecting the first random access resource may include operations, features, means, or instructions for measuring one or more channel parameters of a set of multiple reference signals transmitted using a set of multiple reference signal resources of the set of reference signal resources and selecting the first random access resource based on the one or more measured channel parameters of an associated first reference signal resource meeting one or more measurement criteria.

In some examples of the method, UEs, and non-transitory computer-readable medium described herein, the first random access resource may be selected based on a reference signal received power (RSRP) of a first reference signal received using the first reference signal resource and one or more other RSRP values of one or more other reference signals received using one or more other reference signal resources.

In some examples of the method, UEs, and non-transitory computer-readable medium described herein, the configuration information indicates a quantity of reference signal instances to be measured by the UE prior to selection of the first random access resource.

In some examples of the method, UEs, and non-transitory computer-readable medium described herein, the first random access resource may be further selected based on one or more SSB measurements of a first SSB that are associated with the first random access resource.

Some examples of the method, UEs, and non-transitory computer-readable medium described herein may further include operations, features, means, or instructions for transmitting a beam switch request that indicates a first transmit and receive beam for communications with the UE is to be switched to a second transmit and receive beam, where the first transmit and receive beam corresponds to a first narrow beam associated with the first reference signal resource. In some examples of the method, UEs, and non-transitory computer-readable medium described herein, the configuration information further indicates an index value of each reference signal resource and each reference signal resource is associated with a corresponding narrow beam, and where the beam switch request indicates a second index value associated with the second transmit and receive beam. In some examples of the method, UEs, and non-transitory computer-readable medium described herein, the set of reference signal resources and associated index values may be received in one or more system information blocks.

In some examples of the method, UEs, and non-transitory computer-readable medium described herein, the beam switch request may be transmitted based on one or more measurements associated with the second transmit and receive beam meeting a measurement threshold value for a configured quantity of measurements or for a configured time period.

A method for wireless communications by a network entity is described. The method may include outputting a set of reference locations for a set of SSBs to be transmitted to at least one UE, each SSB of the set of SSBs associated with one or more reference locations of the set of reference locations, and each reference location associated with a random access resource of a set of random access resources, obtaining, from a first UE, a random access message transmitted via a first random access resource of the set of random access resources, and outputting one or more response messages to the first UE using a beam associated with a first reference location that corresponds to the first random access resource.

A network entity for wireless communications is described. The network entity may include one or more memories storing processor executable code, and one or more processors coupled with the one or more memories. The one or more processors may individually or collectively be operable to execute the code to cause the network entity to output a set of reference locations for a set of SSBs to be transmitted to at least one UE, each SSB of the set of SSBs associated with one or more reference locations of the set of reference locations, and each reference location associated with a random access resource of a set of random access resources, obtain, from a first UE, a random access message transmitted via a first random access resource of the set of random access resources, and output one or more response messages to the first UE using a beam associated with a first reference location that corresponds to the first random access resource.

Another network entity for wireless communications is described. The network entity may include means for outputting a set of reference locations for a set of SSBs to be transmitted to at least one UE, each SSB of the set of SSBs associated with one or more reference locations of the set of reference locations, and each reference location associated with a random access resource of a set of random access resources, means for obtaining, from a first UE, a random access message transmitted via a first random access resource of the set of random access resources, and means for outputting one or more response messages to the first UE using a beam associated with a first reference location that corresponds to the first random access resource.

A non-transitory computer-readable medium storing code for wireless communications is described. The code may include instructions executable by one or more processors to output a set of reference locations for a set of SSBs to be transmitted to at least one UE, each SSB of the set of SSBs associated with one or more reference locations of the set of reference locations, and each reference location associated with a random access resource of a set of random access resources, obtain, from a first UE, a random access message transmitted via a first random access resource of the set of random access resources, and output one or more response messages to the first UE using a beam associated with a first reference location that corresponds to the first random access resource.

In some examples of the method, network entities, and non-transitory computer-readable medium described herein, outputting the set of reference locations may include operations, features, means, or instructions for outputting system information that indicates the set of reference locations and associated random access resources. In some examples of the method, network entities, and non-transitory computer-readable medium described herein, the one or more reference locations correspond to global navigation satellite system (GNSS) positions, and where each GNSS position may be associated with a transmit and receive beam that has a smaller coverage area than a SSB beam used to transmit a SSB associated with a reference location.

In some examples of the method, network entities, and non-transitory computer-readable medium described herein, each random access resource of the set of random access resources corresponds to a random access occasion, a random access sequence to be included in an associated random access message, or any combination thereof. In some examples of the method, network entities, and non-transitory computer-readable medium described herein, one or more SSBs of the set of SSBs may be associated with transmit and receive beams having moving coverage areas, and where the first reference location of the UE corresponds to the first reference location based on a time instance associated with the first reference location and ephemeris information associated with the network entity. In some examples of the method, network entities, and non-transitory computer-readable medium described herein, the time instance associated with the first reference location and the ephemeris information associated with the network entity may be provided to the first UE in one or more system information blocks.

Some examples of the method, network entities, and non-transitory computer-readable medium described herein may further include operations, features, means, or instructions for obtaining, from the first UE, a beam switch request that indicates a first beam for communications with the first UE is to be switched to a second beam, where the first beam corresponds to a first narrow beam associated with the first reference location.

Some examples of the method, network entities, and non-transitory computer-readable medium described herein may further include operations, features, means, or instructions for outputting configuration information that indicates a set of reference signal resources in which an index value of each reference signal resource is associated with a corresponding narrow beam, where the beam switch request indicates a second index value associated with the second beam.

In some examples of the method, network entities, and non-transitory computer-readable medium described herein, the set of reference signal resources and associated index values may be provided to the first UE in one or more system information blocks. In some examples of the method, network entities, and non-transitory computer-readable medium described herein, the beam switch request indicates one or more channel measurements associated with the second beam meet a measurement threshold value for a configured quantity of measurements or for a configured time period. In some examples of the method, network entities, and non-transitory computer-readable medium described herein, the beam switch request includes an index value of a second reference location among the set of reference locations that is a nearest reference location to a current location of the first UE.

Some examples of the method, network entities, and non-transitory computer-readable medium described herein may further include operations, features, means, or instructions for obtaining, from the first UE, a beam change request to switch from a first transmit and receive beam associated with the first reference location to a second transmit and receive beam associated with a second reference location of the set of reference locations, where the beam change request may be provided in a MAC control element or may be a random access preamble using a second random access resource associated with the second reference location.

A method for wireless communications by a network entity is described. The method may include outputting configuration information that indicates a set of reference signal resources for reference signal transmissions to at least one UE, where each reference signal resource of the set of reference signal resources is associated with a random access resource of a set of random access resources, obtaining, from a first UE, a random access message transmitted via a first random access resource of the set of random access resources, and outputting one or more response messages to the first UE, the one or more response messages transmitted using a beam associated with the first random access resource.

A network entity for wireless communications is described. The network entity may include one or more memories storing processor executable code, and one or more processors coupled with the one or more memories. The one or more processors may individually or collectively be operable to execute the code to cause the network entity to output configuration information that indicates a set of reference signal resources for reference signal transmissions to at least one UE, where each reference signal resource of the set of reference signal resources is associated with a random access resource of a set of random access resources, obtain, from a first UE, a random access message transmitted via a first random access resource of the set of random access resources, and output one or more response messages to the first UE, the one or more response messages transmitted using a beam associated with the first random access resource.

Another network entity for wireless communications is described. The network entity may include means for outputting configuration information that indicates a set of reference signal resources for reference signal transmissions to at least one UE, where each reference signal resource of the set of reference signal resources is associated with a random access resource of a set of random access resources, means for obtaining, from a first UE, a random access message transmitted via a first random access resource of the set of random access resources, and means for outputting one or more response messages to the first UE, the one or more response messages transmitted using a beam associated with the first random access resource.

A non-transitory computer-readable medium storing code for wireless communications is described. The code may include instructions executable by one or more processors to output configuration information that indicates a set of reference signal resources for reference signal transmissions to at least one UE, where each reference signal resource of the set of reference signal resources is associated with a random access resource of a set of random access resources, obtain, from a first UE, a random access message transmitted via a first random access resource of the set of random access resources, and output one or more response messages to the first UE, the one or more response messages transmitted using a beam associated with the first random access resource.

In some examples of the method, network entities, and non-transitory computer-readable medium described herein, outputting the configuration information may include operations, features, means, or instructions for outputting, for each port of one or more reference signal resources of the set of reference signal resources, an associated random access resource. In some examples of the method, network entities, and non-transitory computer-readable medium described herein, the first random access resource indicates that one or more measured channel parameters of an associated first reference signal resource meet one or more measurement criteria at the first UE.

In some examples of the method, network entities, and non-transitory computer-readable medium described herein, the first random access resource indicates a RSRP of a first reference signal received using an associated first reference signal resource exceeds one or more other RSRP values of one or more other reference signals received using one or more other reference signal resource resources. In some examples of the method, network entities, and non-transitory computer-readable medium described herein, the configuration information indicates a quantity of reference signal instances to be measured by the first UE prior to selection of the first random access resource. In some examples of the method, network entities, and non-transitory computer-readable medium described herein, the first random access resource may be further selected based on one or more SSB measurements of a first SSB that are associated with the first random access resource.

Some examples of the method, network entities, and non-transitory computer-readable medium described herein may further include operations, features, means, or instructions for obtaining, from the first UE, a beam switch request that indicates a first transmit and receive beam for communications with the UE is to be switched to a second transmit and receive beam, where the first transmit and receive beam corresponds to a first narrow beam associated with a first reference signal resource.

In some examples of the method, network entities, and non-transitory computer-readable medium described herein, the configuration information further indicates an index value of each reference signal resource and each reference signal resource may be associated with a corresponding narrow beam, and where the beam switch request indicates a second index value associated with the second transmit and receive beam.

In some examples of the method, network entities, and non-transitory computer-readable medium described herein, the set of reference signal resources and associated index values may be provided in one or more system information blocks. In some examples of the method, network entities, and non-transitory computer-readable medium described herein, the beam switch request indicates one or more channel state information measurements associated with the second transmit and receive beam meet a measurement threshold value for a configured quantity of measurements or for a configured time period.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports beam selection techniques for wireless communications in accordance with one or more aspects of the present disclosure.

FIG. 2 shows an example of a wireless communications system that supports beam selection techniques for wireless communications in accordance with one or more aspects of the present disclosure.

FIG. 3 shows an example of synchronization signal block beam coverage areas of a wireless communications system that supports beam selection techniques for wireless communications in accordance with one or more aspects of the present disclosure.

FIG. 4 shows an example of a process flow that supports beam selection techniques for wireless communications in accordance with one or more aspects of the present disclosure.

FIG. 5 shows an example of a process flow that supports beam selection techniques for wireless communications in accordance with one or more aspects of the present disclosure.

FIGS. 6 and 7 show block diagrams of devices that support beam selection techniques for wireless communications in accordance with one or more aspects of the present disclosure.

FIG. 8 shows a block diagram of a communications manager that supports beam selection techniques for wireless communications in accordance with one or more aspects of the present disclosure.

FIG. 9 shows a diagram of a system including a device that supports beam selection techniques for wireless communications in accordance with one or more aspects of the present disclosure.

FIGS. 10 and 11 show block diagrams of devices that support beam selection techniques for wireless communications in accordance with one or more aspects of the present disclosure.

FIG. 12 shows a block diagram of a communications manager that supports beam selection techniques for wireless communications in accordance with one or more aspects of the present disclosure.

FIG. 13 shows a diagram of a system including a device that supports beam selection techniques for wireless communications in accordance with one or more aspects of the present disclosure.

FIGS. 14 through 21 show flowcharts illustrating methods that support beam selection techniques for wireless communications in accordance with one or more aspects of the present disclosure.

### DETAILED DESCRIPTION

In some wireless communications systems, one or more aerial-based platforms may be part of a non-terrestrial network (NTN), and may be used for some communications with a user equipment (UE). Such aerial platforms may include, for example, a space satellite, a balloon, a dirigible, an airplane, a drone, an unmanned aerial vehicle, other vehicle, or any combination thereof, which may support communications from a generally non-terrestrial, overhead, or elevated position. As used herein, the term satellite may be used to generally refer to any such aerial platforms. In some cases, a satellite may provide a relatively large coverage area, particularly in comparison to a terrestrial component such as a terrestrial base station or terrestrial transmission-reception point (TRP). In some non-terrestrial networks (NTNs), due to the distance between a terrestrial UE and a satellite, relatively narrow beams may provide more efficient communications than relatively wider beams. However, transmission of synchronization signal blocks (SSBs) used for initial system access using relatively narrow beams may not be feasible for such a satellite due to the quantity of SSBs that would need to be transmitted.

In accordance with various techniques discussed herein, it may be beneficial for a satellite to transmit SSBs using a relatively wide beam to provide SSBs in a relatively large SSB beam coverage area, and transmit data communications via relatively narrow beams that provide more efficient data transmission (e.g., larger antenna gain and hence larger signal effective isotropically radiated power (EIRP)). This may allow the satellite to transmit a relatively small quantity of SSBs with a wide coverage area, and transmit data using narrow beams that are identified for one or more particular UEs. In some aspects, a transmitting satellite may transmit system information blocks (SIBs) that correlate SSB or reference signal transmissions to particular random access channel (RACH) resources. The SIBs (e.g., SIB1) may indicate RACH resources associated with different locations that correspond to narrow beams, or may indicate RACH resources associated with different CSI-RS resources. In aspects where RACH resources are associated with different locations, a wide beam SSB may be transmitted that is associated with multiple different narrow beams that each have an associated center point location, and a particular narrow beam may be selected based on a location of the UE (e.g., a global navigation satellite system (GNSS) location determined by a GNSS module at the UE) and a RACH resource that is associated with that location.

In some aspects, a beam may be a moving beam, and the location associated with the RACH resource may be based on a reference time point and an ephemeris of the transmitting satellite (e.g., which may be communicated to UEs in a SIB, such as SIB19). In aspects where RACH resources are associated with different CSI-RS resources, a UE may select a RACH resource associated with a best measured CSI reference signal received power (RSRP), and a RACH message transmitted using the selected RACH resource indicates to the network the particular narrow beam to use for subsequent communications. Further, in some aspects, a UE may signal a request for a beam switch based on a report that identifies a CSI-RS resource associated with a preferred beam.

Such techniques may provide for more efficient NTN communications by providing relatively wide-area SSBs in conjunction with relatively narrow beams for data communications. Such techniques may provide for enhanced initial access to a NTN which may be beneficial in cases where link budget is tight in uplink, while providing subsequent communications using more targeted and efficient narrow beams. Further, such techniques may provide for reduced power consumption through a reduced quantity of SSB transmissions for a satellite coverage area.

Aspects of the disclosure are initially described in the context of wireless communications systems. Aspects of the disclosure are further illustrated by and described with reference to process flows, apparatus diagrams, system diagrams, and flowcharts that relate to beam selection techniques for wireless communications.

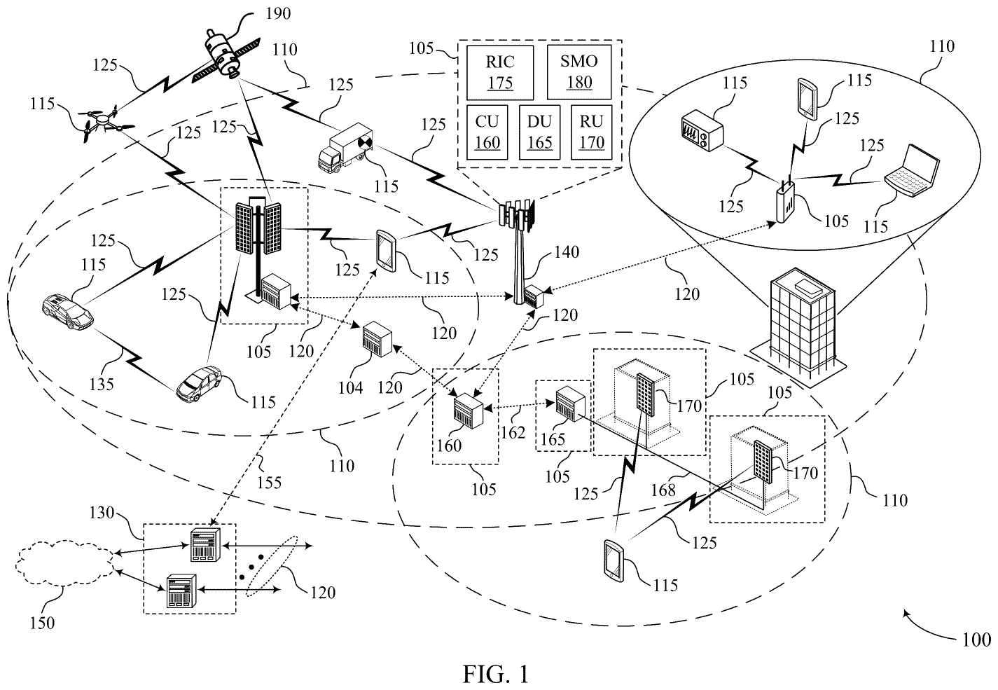

FIG. 1 shows an example of a wireless communications system 100 that supports beam selection techniques for wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Wireless communications system 100 may also include one or more satellites 190. A satellite 190 may communicate with network entity 105, which may be referred to as gateways in an NTN, and UEs 115, which may include other high altitude or terrestrial communications devices. In some examples, a satellite 190 itself may be an example of a network entity 105. A satellite 190 may be any suitable type of communication satellite configured to relay or otherwise support communications between different devices in the wireless communications system 100. A satellite 190 may be an example of a space satellite, a balloon, a dirigible, an airplane, a drone, an unmanned aerial vehicle, or other vehicle which may support communications from a generally non-terrestrial, overhead, or elevated position. In some examples, a satellite 190 may be in a geosynchronous or geostationary earth orbit, a low earth orbit, or a medium earth orbit. A satellite 190 may be a multi-beam satellite configured to provide service for multiple service beam coverage areas in a configured geographical service area. The satellite 190 may be any distance away from the surface of the earth or other reference surface.

In some examples, a cell may be provided or established by a satellite 190 as part of an NTN. A satellite 190 may, in some cases, perform the functions of a network entity 105, act as a bent-pipe satellite, or act as a regenerative satellite, or a combination thereof. In some examples, a satellite 190 may be an example of a smart satellite, or a satellite with intelligence or other communications processing capability. For example, a smart satellite may be configured to perform more functions than a regenerative satellite (e.g., may be configured to perform particular algorithms beyond those used in regenerative satellites, to be reprogrammed). In a bent-pipe transponder configuration, a satellite 190 may be configured to receive signals from ground stations (e.g., gateways, network entity 105, a core network 130) and transmit those signals to different ground stations or terminals (e.g., UEs 115, network entity 105). In some cases, a satellite 190 supporting a bent-pipe transponder configuration may amplify signals or shift from uplink frequencies to downlink frequencies. In some examples, a satellite 190 supporting a regenerative transponder configuration may relay signals like a bent-pipe transponder configuration, but may also use on-board processing to perform other functions. Examples of these other functions may include demodulating a received signal, decoding a received signal, re-encoding a signal to be transmitted, modulating the signal to be transmitted, or a combination thereof. In some examples, a satellite 190 supporting a bent pipe transponder configuration or regenerative transponder configuration may receive a signal from a network entity 105 and may relay the signal to a UE 115 or network entity 105, or vice-versa.

In accordance with various aspects, a satellite 190 may transmit SSBs using a relatively wide beam to provide SSBs in a relatively large SSB beam coverage area, and transmit data communications via relatively narrow beams that provide more efficient data transmission. In some aspects, a transmitting satellite may transmit SIBs that correlate SSB or reference signal transmissions to particular RACH resources. The SIBs (e.g., SIB1) may indicate RACH resources associated with different locations that correspond to narrow beams, or may indicate RACH resources associated with different CSI-RS resources. In aspects where RACH resources are associated with different locations, a wide beam SSB may be transmitted that is associated with multiple different narrow beams that each have an associated center point location, and a particular narrow beam may be selected based on a location of the UE (e.g., a GNSS location determined by a GNSS module at the UE) and a RACH resource that is associated with that location. In aspects where RACH resources are associated with different reference signal resources (e.g., channel state information reference signal (CSI-RS) resources), a UE may select a RACH resource associated with a favorable reference signal measurement (e.g., a best measured CSI-RS RSRP), and a RACH message transmitted using the selected RACH resource indicates to the network the particular narrow beam to use for subsequent communications. Further, in some aspects, a UE may signal a request for a beam switch based on a report that identifies a CSI-RS resource associated with a preferred beam.

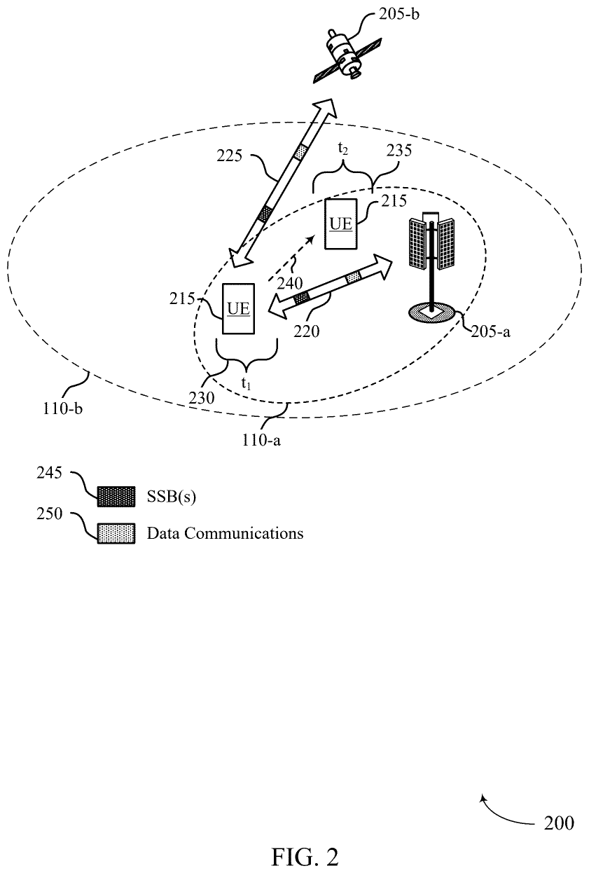

FIG. 2 shows an example of a wireless communications system 200 that supports beam selection techniques for wireless communications in accordance with one or more aspects of the present disclosure. In the example of FIG. 2 a UE 215 may communicate with a network entity 205-a, a satellite or NTN TRP 205-b, or any combination thereof. In some examples, the network entity 205-a may be an example of a terrestrial network entity or a non-terrestrial network entity with coverage area or cell 110-a, and NTN TRP 205-b may be an example of an NTN network entity, and may be associated with coverage area or cell 110-b.

In this example, the UE 215 may communicate with one or both of the network entity 205-a using a first communications link 220 or the NTN TRP 205-b using a second communications link 225. It is noted that although various examples discussed herein discuss a PLMN accessed through a NTN such as via NTN TRP 205-b, such techniques may also be used for some terrestrial networks that may have one or more TRPs (such as network entity 205-a) that have relatively large coverage areas 110. Continuing with the example of FIG. 2, the UE 215 may initially be located at a first location at a first time 230 (t₁), and at a second time 235 (t₂) the UE 215 may change location as indicated by arrow 240. In accordance with various aspects discussed herein, the first location and the second location may be associated with a same SSB beam transmitted by NTN TRP 205-b, and associated with different narrow beams that may be used for data communications. One or more SSB beams may be relatively wide coverage beams that may be used to transmit one or more SSBs 245, and narrow beams may be relatively narrow coverage beams that may be used to transmit data communications 250.

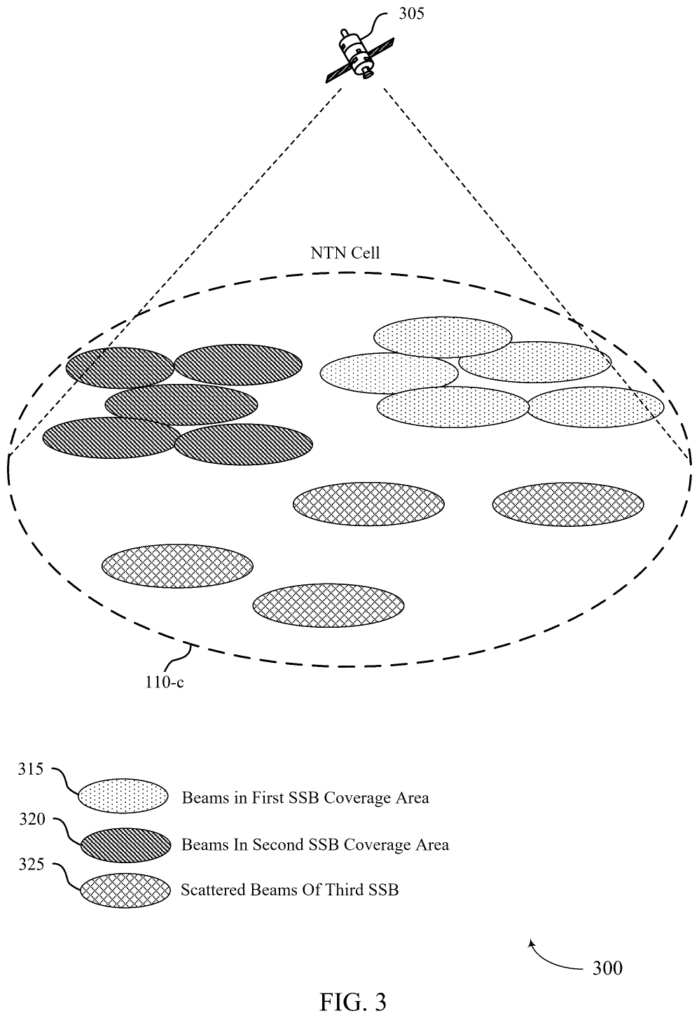

In some aspects, the NTN TRP 205-b may be a low earth orbit (LEO) satellite that can support a few hundreds to more than a thousand beams or cells. In some cases, due to limited transmit power and a quantity of available radio frequency (RF) chains, only a small portion of the satellite beams can transmit at any given time, and a larger SSB footprint may provide for overhead reduction. For example, SSB transmission may consume a relatively large amount of overhead and may limit the coverage ratio of a satellite (e.g., a ratio of actual coverage and desirable coverage for a given minimal elevation angle). Reducing SSB overhead in terms of power and downlink time occupancy by transmitting SSBs with a larger footprint than data may thus be beneficial by enhancing coverage and reducing associated overhead. FIG. 3 shows examples of different SSB coverage areas for different SSBs that may be transmitted by a network entity such as the NTN TRP 205-b.

FIG. 3 shows an example of a synchronization signal block beam coverage areas of a wireless communications system 300 that supports beam selection techniques for wireless communications in accordance with one or more aspects of the present disclosure. In the example of FIG. 3 a network entity 305 (e.g., a satellite or NTN TRP) may be an example of a NTN entity with coverage area or cell 110-c, and NTN TRP 205-b may be an example of an NTN network entity, and may be associated with coverage area or cell 110-c.

In this example, a first SSB may be associated with a first set of narrow beams 315, where the first set of narrow beams 315 may be within a first SSB beam footprint. Further, a second SSB may be associated with a second set of narrow beams 320, where the second set of narrow beams 320 may be within a second SSB beam footprint. In this example, a third SSB may be associated with a third set of narrow beams 325, and a third SSB beam footprint may cover multiple discontinuous data beams 325 that use a same frequency. As discussed, a relatively larger SSB footprint may be useful for deployments limited by the number of RF chains, to provide SSBs over a relatively wide area with relatively low overhead.

In accordance with various aspects, a UE may inform the network entity 305 of a narrow beam that is to be used for data communications with the UE. In some cases, a UE may inform the network entity 305 of the narrow beam at the time of a random access procedure. In some cases, the network entity 305 may transmit SSBs and one or more SIBs using the same wider SSB beams, and narrower beams may be used for data communications which may allow for larger antenna gain for both downlink (e.g., other than SIB transmissions) and uplink communications. In some aspects, in order to notify the network entity 305 of a selected narrow beam, the network entity 305 may signal a set of reference locations (e.g., the GNSS position of the center of the target narrow beams within the coverage of the SSB beam) and for each reference location the associated RACH resource (e.g., random access occasion (RO), RACH sequence sets, RACH preamble, and the like) in one or more SIBs (e.g., SIB1). The UE may transmit a RACH message using the resource associated with a reference location nearest to its own location (e.g., as determined from a GNSS at the UE, or from any other location determination technique such as triangulation from two or more terrestrial transmitters). In some aspects, beams from network entity 305 may be earth-moving beams (e.g., the beams sweep across a swath of earth over time). In such cases, a time instance may be defined for the reference location, and UE may derive a location variation from narrow beam reference locations based on an ephemeris of the network entity 305. For example, network entity 305 may transmit ephemeris information in a SIB (e.g., SIB19), and the UE may use the ephemeris information and the associated time instance to determine the reference location, which may be compared to a location of the UE to select a RACH resource.

In some aspects, different reference signals (e.g., channel state information reference signals (CSI-RSs) may be associated with different RACH resources. For example, different CSI-RSs may be mapped to different RACH resources in one or more SIBs, each of which may be associated with an index value. In some aspects, the the network entity 305 may configure a CSI-RS resource (or CSI-RS resource set), and for each port (or each resource in the set) an associated RACH resource. The UE may transmit a RACH message using the resource associated with a favorable reference signal measurement (e.g., a resource associated with a best CSI-RS RSRP). In some cases, the reference signal measurement may be a RSRP measurement of one or more reference signal transmissions. In some cases, the network may configure a quantity of reference signal instances that are to be measured. Further, in some cases, a UE may consider reference signal measurements together with SSB measurements to select an associate RACH resource.

In some aspects, when one SSB beam has an associated coverage area that includes multiple narrow data beams, a beam switch may occur. In some cases, the UE may inform the network that a beam switch is desired. In some cases, such beam switching can be made transparent to UE using reference signal transmissions (e.g., CSI-RS), in which the network entity 305 may switch the beam based on UE reports of reference signal measurements (e.g., CSI-RSRP). In some aspects, a UE-triggered report may be provided based on a configuration for a reporting. For example, the UE may report a beam change (e.g., a new CSI-RS index) when the UE measures a different CSI-RS that is better than a current CSI-RS. In some cases, a minimum measurement frequency may be configured (e.g., in terms of a number of the periods of the CSI-RS), and/or a latency of report (e.g., versus an actual switching time). In some cases, a beam switch based on reference signal measurements may be signaled if a measured reference signal value exceeds a current reference signal value by a threshold amount, which may mitigate frequent beam switch requests if the different beams are not substantially different in the associated measured parameter.

In some aspects that use location-based RACH resources, a UE may be configured with CSI-RS resources for measurement, and the UE may report a beam change (e.g., an index of the nearest reference location) based on the distance between its own location (e.g., GNSS location) and the configured reference locations. In some cases, such a report may be transmitted using a MAC control element (CE), or in a RACH message using the corresponding RACH resource.

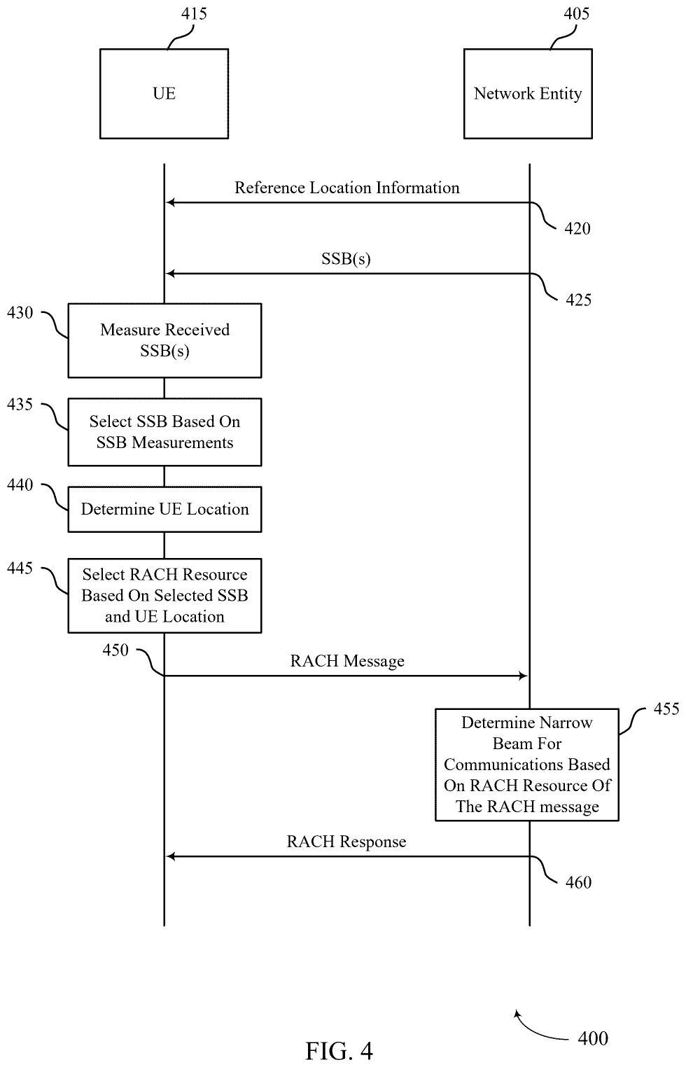

FIG. 4 shows an example of a process flow 400 that supports beam selection techniques for wireless communications in accordance with one or more aspects of the present disclosure. In some cases, the process flow 400 may implement or be implemented by aspects of the wireless communications system 100, the wireless communications system 200, the wireless communications system 300, or any combination thereof. For example, the process flow 400 may include one or more UEs 415 and one or more network entities 405, which may be examples of the corresponding devices as described herein. In the following description of the process flow 400, the operations between the UE 415 and the network entity 405 may be transmitted in a different order than the example order shown, or the operations performed by the UE 415 and the network entity 405 may be performed in different orders or at different times. Some operations may also be omitted from the process flow 400, and other operations may be added to the process flow 400.

At 420, the network entity 405 may transmit, and the UE 415 may receive, reference location information for one or more SSBs. In some cases, the reference location information may include location coordinates (e.g., GNSS location coordinates, a radius associated with each location, or any combination thereof) for multiple reference locations that correspond to a location of a narrow beam, and multiple reference locations may be associated with a same SSB transmission. In some cases, the reference location information may be provided in one or more SIBs (e.g., SIB1). In some aspects, each reference location may be associated with a corresponding RACH resource (e.g., a RO, RACH preamble, RACH sequence, sequence offset, or any combinations thereof). In some aspects, a time instance may be associated with the reference location information, and a current reference location may be determined based on the time instance and ephemeris information of the network entity 405 (e.g., ephemeris information provided in SIB19).

At 425, the network entity 405 may transmit, and the UE 415 may receive, one or more SSBs. In some aspects, different SSBs may be transmitted using different SSB beams that may be relatively wide beams, where each SSB beam is associated with multiple narrow beams.

At 430, the UE 415 may measure one or more received SSBs. In some cases, the UE 415 may measure a RSRP of one or more reference signals transmitted in the received SSBs (e.g., a primary synchronization signal (PSS), a secondary synchronization signal (SSS)).

At 435, the UE 415 may select a SSB based on the SSB measurements. For example, the UE 415 may select a SSB that has a favorable RSRP (e.g., a SSB that has a best measured RSRP).

At 440, the UE 415 may determine the location of the UE 415. In some aspects, the UE 415 may include a positioning module (e.g., a GNSS module) and may determine a location of the UE 415 based on information from the positioning module. For example, the UE 415 may determine the GNSS coordinates of the UE 415. In some cases, additionally, or alternatively, the UE 415 may use terrestrial-based positioning (e.g., based on triangulation or signal strengths of one or more terrestrial transmitters), network-assisted positioning, or any combinations thereof.

At 445, the UE 415 may select a RACH resource based on the selected SSB and the UE 415 location. In some aspects, the UE 415 may select a RACH resource that corresponds to the closest reference location of the configured reference locations. At 450, the UE 415 may transmit, and the network entity 405 may receive, a RACH message using the selected RACH resource. In some cases, the UE 415 may transmit the RACH message using a narrow beam that is associated with the selected RACH resource.

At 455, the network entity 405 may determine a narrow beam for communications based on the RACH resource used to transmit the RACH message. In some aspects, the network entity 405 may match the RACH resource to the narrow beam based on the reference locations and associated RACH resources that were provided to the UE 415 with the reference location information. At 460, the network entity 405 may transmit, and the UE 415 may receive, a RACH response. The RACH response may be transmitted using the narrow beam that is determined based on the RACH resource used to transmit the RACH message.

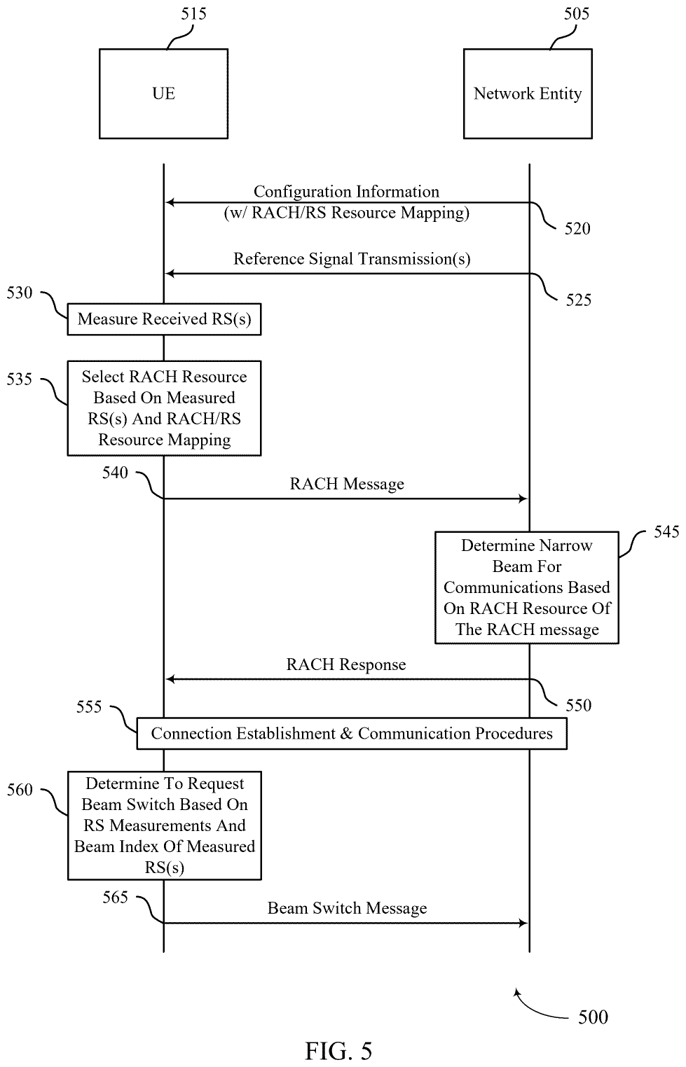

FIG. 5 shows an example of a process flow 500 that supports beam selection techniques for wireless communications in accordance with one or more aspects of the present disclosure. In some cases, the process flow 500 may implement or be implemented by aspects of the wireless communications system 100, the wireless communications system 200, the wireless communications system 300, or any combination thereof. For example, the process flow 500 may include one or more UEs 515 and one or more network entities 505, which may be examples of the corresponding devices as described herein. In the following description of the process flow 500, the operations between the UE 515 and the network entity 505 may be transmitted in a different order than the example order shown, or the operations performed by the UE 515 and the network entity 505 may be performed in different orders or at different times. Some operations may also be omitted from the process flow 500, and other operations may be added to the process flow 500.

At 520, the network entity 505 may transmit, and the UE 515 may receive, configuration information that may include a mapping between reference signal resources and RACH resources. In some cases, the configuration information may be provided in one or more SIBs (e.g., SIB1). In some aspects, each reference signal (e.g., CSI-RS port) may be associated with a corresponding RACH resource (e.g., a RO, RACH preamble, RACH sequence, sequence offset, or any combinations thereof).

At 525, the network entity 505 may transmit, and the UE 515 may receive, one or more reference signals. In some aspects, different reference signals may be transmitted using different narrow beams.

At 530, the UE 515 may measure one or more received reference signals. In some cases, the UE 515 may measure a RSRP of one or more reference signals transmitted in the reference signal resources (e.g., CSI-RS ports).

At 535, the UE 515 may select a RACH resource based on the measured reference signals and associated RACH to reference signal mapping. In some aspects, the UE 515 may select a RACH resource that corresponds to a CSI-RS with a favorable measurement (e.g., a CSI-RS with a best RSRP). At 540, the UE 515 may transmit, and the network entity 505 may receive, a RACH message using the selected RACH resource. In some cases, the UE 515 may transmit the RACH message using a narrow beam that is associated with the selected RACH resource.

At 545, the network entity 505 may determine a narrow beam for communications based on the RACH resource used to transmit the RACH message. In some aspects, the network entity 505 may match the RACH resource to the narrow beam based on the RACH to reference signal mapping provided to the UE 515 with the configuration information. At 550, the network entity 505 may transmit, and the UE 515 may receive, a RACH response. The RACH response may be transmitted using the narrow beam that is determined based on the RACH resource used to transmit the RACH message.

At 555, the UE 515 and network entity 505 may perform connection establishment procedures, and communication procedures, using the narrow beam indicated by the selected RACH resource. At 560, the UE 515 may determine to request a beam switch based on reference signal measurements and a beam index of a selected reference signal. For example, the UE 515 may measure multiple CSI-RSs, and determine that a CSI-RS associated with a different CSI-RS port than selected for the RACH message has a better channel measurement (e.g., a better RSRP, or a RSRP that exceeds that of the current CSI-RS port by a threshold amount). At 565, the UE 515 may transmit, and the network entity 505 may receive, a beam switch message that indicates the request to switch beams. In some cases, the beam switch message may be transmitted in a MAC-CE that indicates an index value associated with the desired beam, according to the configuration information. In some cases, the beam switch message may be a RACH message that is transmitted using a RACH resource associated with the desired beam.

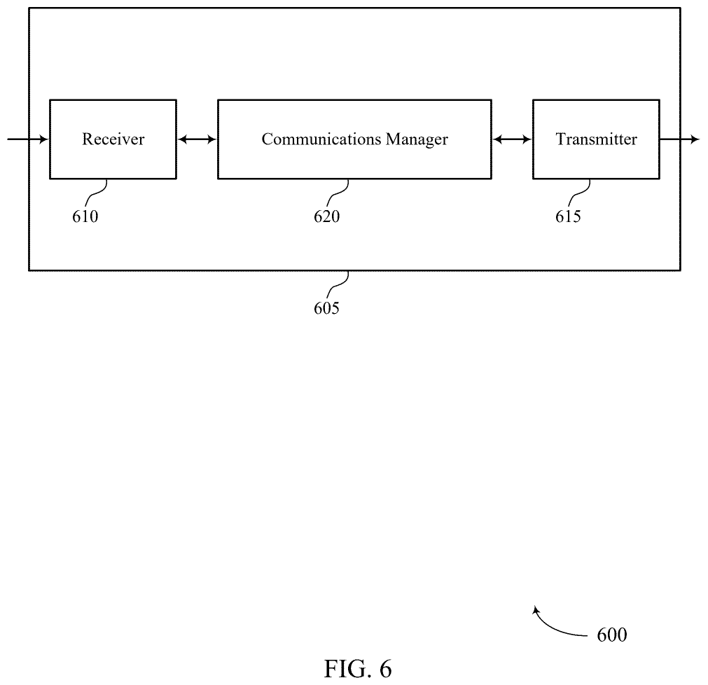

FIG. 6 shows a block diagram 600 of a device 605 that supports beam selection techniques for wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to beam selection techniques for wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beam selection techniques for wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of beam selection techniques for wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a set of reference locations for a set of SSBs transmitted by a network entity, each SSB of the set of SSBs associated with one or more reference locations of the set of reference locations, and each reference location associated with a random access resource of a set of random access resources. The communications manager 620 is capable of, configured to, or operable to support a means for selecting a first random access resource of the set of random access resources based on a first location of the UE corresponding to a first reference location and on one or more measured channel parameters of a first SSB associated with the first reference location. The communications manager 620 is capable of, configured to, or operable to support a means for transmitting a random access message using the first random access resource.

Additionally, or alternatively, the communications manager 620 may support wireless communications in accordance with examples as disclosed herein. For example, the communications manager 620 is capable of, configured to, or operable to support a means for receiving configuration information that indicates a set of reference signal resources and a random access resource associated with each reference signal resource of the set of reference signal resources. The communications manager 620 is capable of, configured to, or operable to support a means for selecting a first random access resource based on one or more measured channel parameters of a first reference signal resource of the set of reference signal resources. The communications manager 620 is capable of, configured to, or operable to support a means for transmitting a random access message using the first random access resource.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for narrow beam selection based on signals received at a UE, which may allow for relatively wide coverage SSB transmissions with reduced overhead, and may provide for more efficient communications.

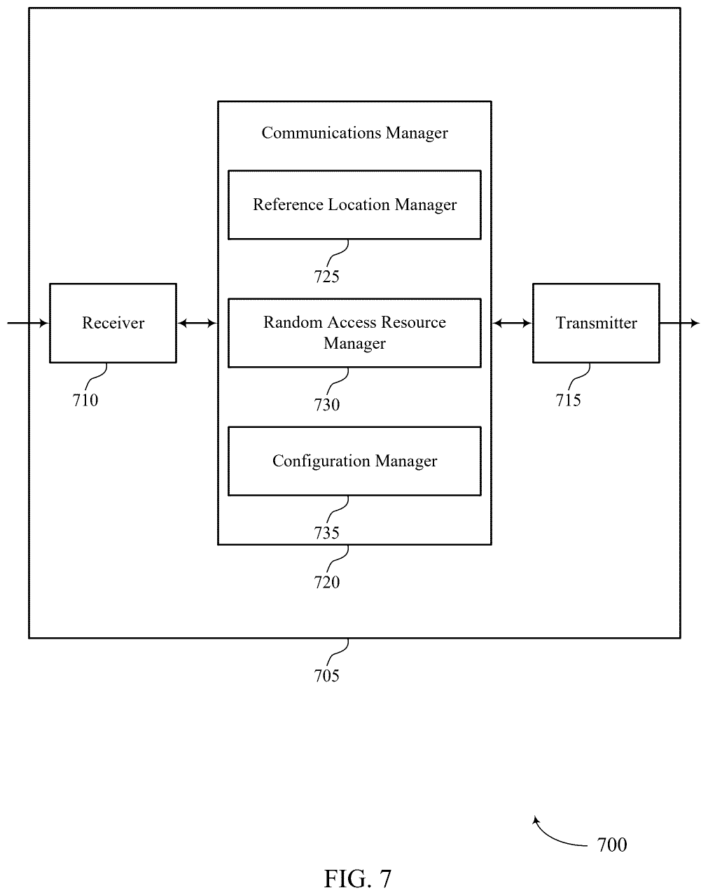

FIG. 7 shows a block diagram 700 of a device 705 that supports beam selection techniques for wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to beam selection techniques for wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to beam selection techniques for wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of beam selection techniques for wireless communications as described herein. For example, the communications manager 720 may include a reference location manager 725, a random access resource manager 730, a configuration manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The reference location manager 725 is capable of, configured to, or operable to support a means for receiving a set of reference locations for a set of SSBs transmitted by a network entity, each SSB of the set of SSBs associated with one or more reference locations of the set of reference locations, and each reference location associated with a random access resource of a set of random access resources. The random access resource manager 730 is capable of, configured to, or operable to support a means for selecting a first random access resource of the set of random access resources based on a first location of the UE corresponding to a first reference location and on one or more measured channel parameters of a first SSB associated with the first reference location. The random access resource manager 730 is capable of, configured to, or operable to support a means for transmitting a random access message using the first random access resource.

Additionally, or alternatively, the communications manager 720 may support wireless communications in accordance with examples as disclosed herein. The configuration manager 735 is capable of, configured to, or operable to support a means for receiving configuration information that indicates a set of reference signal resources and a random access resource associated with each reference signal resource of the set of reference signal resources. The random access resource manager 730 is capable of, configured to, or operable to support a means for selecting a first random access resource based on one or more measured channel parameters of a first reference signal resource of the set of reference signal resources. The random access resource manager 730 is capable of, configured to, or operable to support a means for transmitting a random access message using the first random access resource.

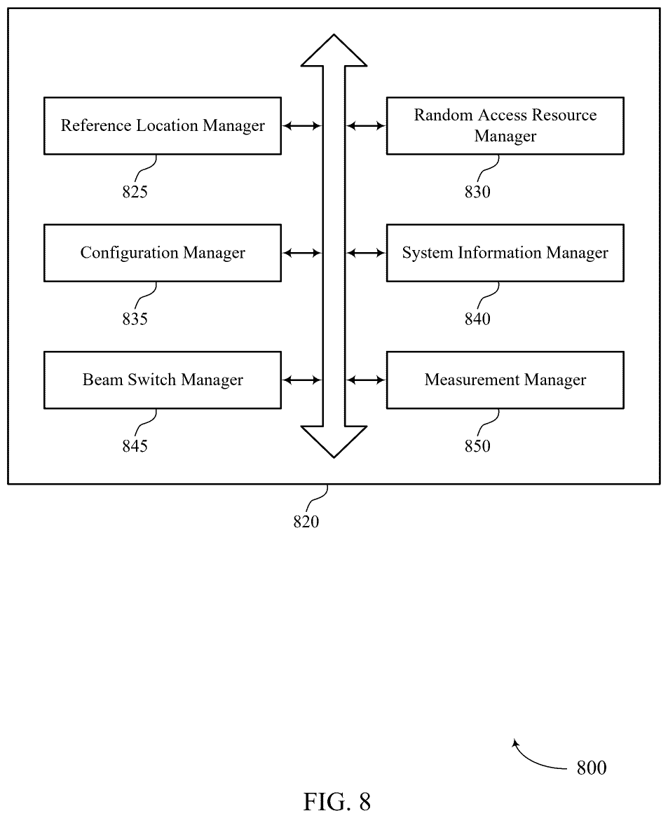

FIG. 8 shows a block diagram 800 of a communications manager 820 that supports beam selection techniques for wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of beam selection techniques for wireless communications as described herein. For example, the communications manager 820 may include a reference location manager 825, a random access resource manager 830, a configuration manager 835, a system information manager 840, a beam switch manager 845, a measurement manager 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The reference location manager 825 is capable of, configured to, or operable to support a means for receiving a set of reference locations for a set of SSBs transmitted by a network entity, each SSB of the set of SSBs associated with one or more reference locations of the set of reference locations, and each reference location associated with a random access resource of a set of random access resources. The random access resource manager 830 is capable of, configured to, or operable to support a means for selecting a first random access resource of the set of random access resources based on a first location of the UE corresponding to a first reference location and on one or more measured channel parameters of a first SSB associated with the first reference location. In some examples, the random access resource manager 830 is capable of, configured to, or operable to support a means for transmitting a random access message using the first random access resource.

In some examples, to support receiving the set of reference locations, the system information manager 840 is capable of, configured to, or operable to support a means for receiving system information that indicates the set of reference locations and associated random access resources. In some examples, the one or more reference locations correspond to GNSS positions, and where each GNSS position is associated with a transmit and receive beam that has a smaller coverage area than a SSB beam used to transmit a SSB associated with a reference location. In some examples, each random access resource of the set of random access resources corresponds to a random access occasion, a random access sequence to be included in an associated random access message, or any combination thereof.

In some examples, the reference location manager 825 is capable of, configured to, or operable to support a means for determining that the first location of the UE corresponds to the first reference location based on a time instance associated with the first reference location and ephemeris information associated with the network entity. In some examples, the time instance associated with the first reference location is explicitly indicated or pre-defined with reference to a reception time of a system information block that carries the time instance.

In some examples, the beam switch manager 845 is capable of, configured to, or operable to support a means for transmitting a beam switch request that indicates a first beam for communications with the UE is to be switched to a second beam, where the first beam corresponds to a first narrow beam associated with the first location. In some examples, the beam switch manager 845 is capable of, configured to, or operable to support a means for receiving configuration information that indicates a set of reference signal resources in which an index value of each reference signal resource is associated with a corresponding narrow beam, where the beam switch request indicates a second index value associated with the second beam. In some examples, the set of reference signal resources and associated index values are received in one or more system information blocks.

In some examples, the beam switch request is transmitted based on one or more channel measurements associated with the second beam meeting a measurement threshold value for a configured quantity of measurements or for a configured time period. In some examples, the beam switch request includes an index value of a second reference location among the set of reference locations that is a nearest reference location to a current location of the UE.

In some examples, the beam switch manager 845 is capable of, configured to, or operable to support a means for transmitting a beam switch request to switch from a first transmit and receive beam associated with the first location to a second transmit and receive beam associated with a second reference location of the set of reference locations, where the beam switch request is transmitted in a MAC-CE or is a random access preamble using a second random access resource associated with the second reference location. In some examples, the random access preamble is configured by the network entity.

Additionally, or alternatively, the communications manager 820 may support wireless communications in accordance with examples as disclosed herein. The configuration manager 835 is capable of, configured to, or operable to support a means for receiving configuration information that indicates a set of reference signal resources and a random access resource associated with each reference signal resource of the set of reference signal resources. In some examples, the random access resource manager 830 is capable of, configured to, or operable to support a means for selecting a first random access resource based on one or more measured channel parameters of a first reference signal resource of the set of reference signal resources. In some examples, the random access resource manager 830 is capable of, configured to, or operable to support a means for transmitting a random access message using the first random access resource.

In some examples, to support receiving the configuration information, the random access resource manager 830 is capable of, configured to, or operable to support a means for receiving, for each port of one or more reference signal resources of the set of reference signal resources, an associated random access resource.

In some examples, to support selecting the first random access resource, the measurement manager 850 is capable of, configured to, or operable to support a means for measuring one or more channel parameters of a set of multiple reference signals transmitted using a set of multiple reference signal resources of the set of reference signal resources. In some examples, to support selecting the first random access resource, the measurement manager 850 is capable of, configured to, or operable to support a means for selecting the first random access resource based on the one or more measured channel parameters of an associated first reference signal resource meeting one or more measurement criteria.

In some examples, the first random access resource is selected based on a RSRP of a first reference signal received using the first reference signal resource and one or more other RSRP values of one or more other reference signals received using one or more other reference signal resources. In some examples, the configuration information indicates a quantity of reference signal instances to be measured by the UE prior to selection of the first random access resource. In some examples, the first random access resource is further selected based on one or more SSB measurements of a first SSB that is associated with the first random access resource.

In some examples, the beam switch manager 845 is capable of, configured to, or operable to support a means for transmitting a beam switch request that indicates a first transmit and receive beam for communications with the UE is to be switched to a second transmit and receive beam, where the first transmit and receive beam corresponds to a first narrow beam associated with the first reference signal resource. In some examples, the configuration information further indicates an index value of each reference signal resource and each reference signal resource is associated with a corresponding narrow beam, and where the beam switch request indicates a second index value associated with the second transmit and receive beam. In some examples, the set of reference signal resources and associated index values are received in one or more system information blocks. In some examples, the beam switch request is transmitted based on one or more measurements associated with the second transmit and receive beam meeting a measurement threshold value for a configured quantity of measurements or for a configured time period.

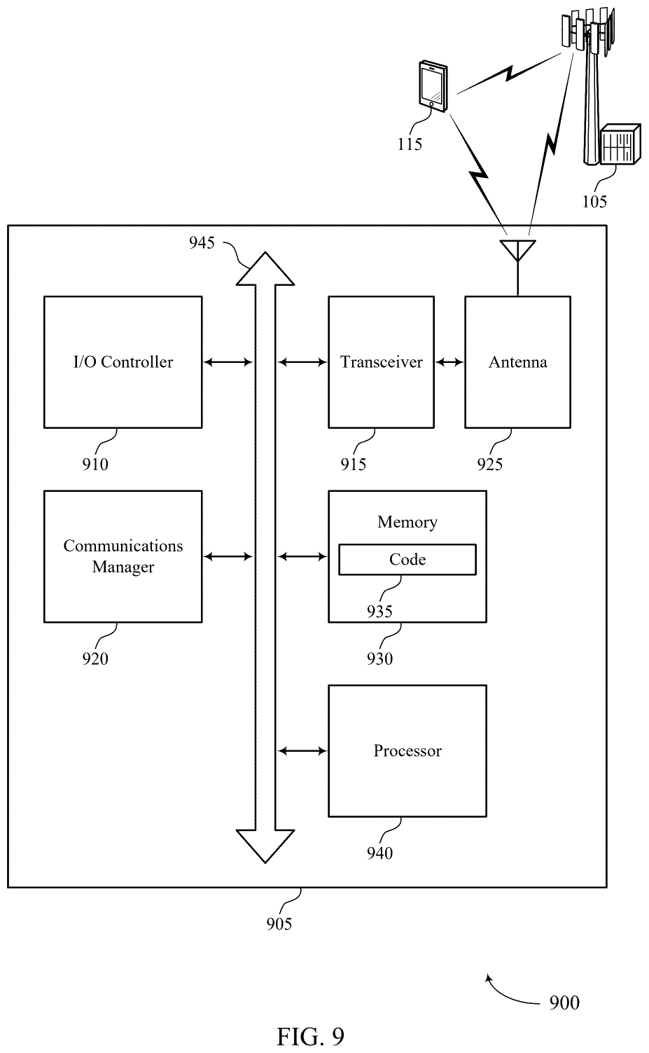

FIG. 9 shows a diagram of a system 900 including a device 905 that supports beam selection techniques for wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting beam selection techniques for wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a set of reference locations for a set of SSBs transmitted by a network entity, each SSB of the set of SSBs associated with one or more reference locations of the set of reference locations, and each reference location associated with a random access resource of a set of random access resources. The communications manager 920 is capable of, configured to, or operable to support a means for selecting a first random access resource of the set of random access resources based on a first location of the UE corresponding to a first reference location and on one or more measured channel parameters of a first SSB associated with the first reference location. The communications manager 920 is capable of, configured to, or operable to support a means for transmitting a random access message using the first random access resource.

Additionally, or alternatively, the communications manager 920 may support wireless communications in accordance with examples as disclosed herein. For example, the communications manager 920 is capable of, configured to, or operable to support a means for receiving configuration information that indicates a set of reference signal resources and a random access resource associated with each reference signal resource of the set of reference signal resources. The communications manager 920 is capable of, configured to, or operable to support a means for selecting a first random access resource based on one or more measured channel parameters of a first reference signal resource of the set of reference signal resources. The communications manager 920 is capable of, configured to, or operable to support a means for transmitting a random access message using the first random access resource.

By including or configuring the communications manager 920 in accordance with examples as described herein, the device 905 may support techniques for narrow beam selection based on signals received at a UE, which may allow for relatively wide coverage SSB transmissions with reduced overhead, and may provide for more efficient communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of beam selection techniques for wireless communications as described herein, or the at least one processor 940 and the at least one memory 930 may be otherwise configured to, individually or collectively, perform or support such operations.

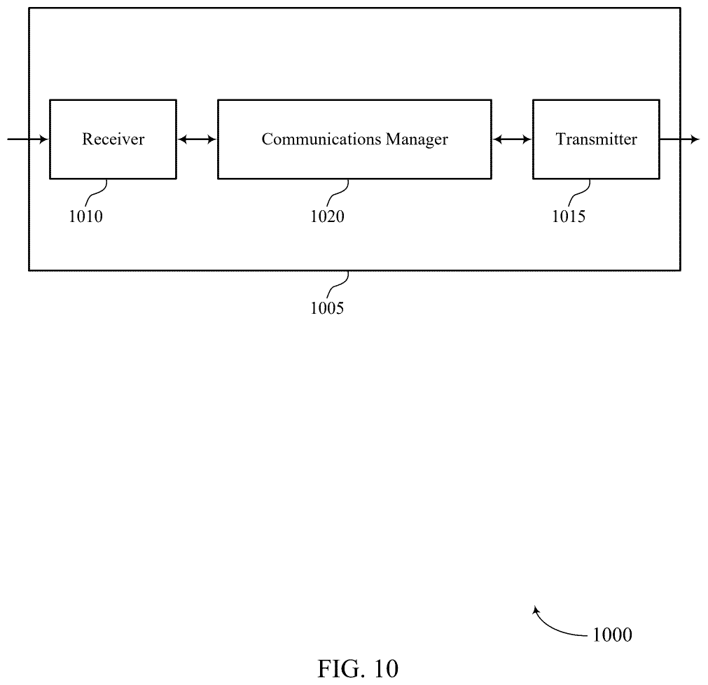

FIG. 10 shows a block diagram 1000 of a device 1005 that supports beam selection techniques for wireless communications in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of beam selection techniques for wireless communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a set of reference locations for a set of SSBs to be transmitted to at least one UE, each SSB of the set of SSBs associated with one or more reference locations of the set of reference locations, and each reference location associated with a random access resource of a set of random access resources. The communications manager 1020 is capable of, configured to, or operable to support a means for obtaining, from a first UE, a random access message transmitted via a first random access resource of the set of random access resources. The communications manager 1020 is capable of, configured to, or operable to support a means for outputting one or more response messages to the first UE using a beam associated with a first reference location that corresponds to the first random access resource.

Additionally, or alternatively, the communications manager 1020 may support wireless communications in accordance with examples as disclosed herein. For example, the communications manager 1020 is capable of, configured to, or operable to support a means for outputting configuration information that indicates a set of reference signal resources for reference signal transmissions to at least one UE, where each reference signal resource of the set of reference signal resources is associated with a random access resource of a set of random access resources. The communications manager 1020 is capable of, configured to, or operable to support a means for obtaining, from a first UE, a random access message transmitted via a first random access resource of the set of random access resources. The communications manager 1020 is capable of, configured to, or operable to support a means for outputting one or more response messages to the first UE, the one or more response messages transmitted using a beam associated with the first random access resource.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for narrow beam selection based on signals received at a UE, which may allow for relatively wide coverage SSB transmissions with reduced overhead, and may provide for more efficient communications.

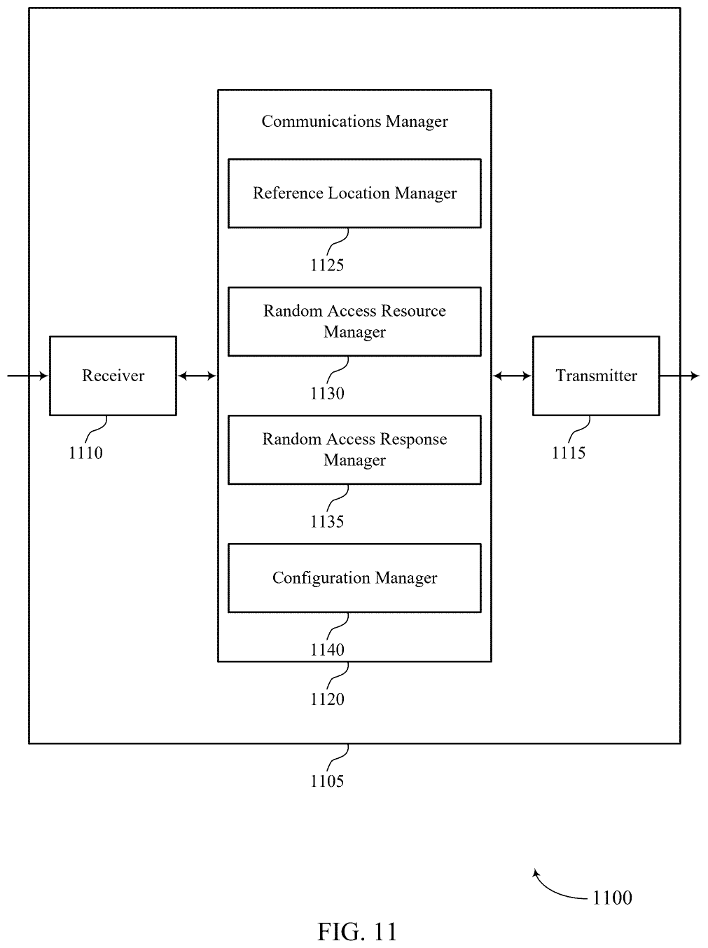

FIG. 11 shows a block diagram 1100 of a device 1105 that supports beam selection techniques for wireless communications in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of beam selection techniques for wireless communications as described herein. For example, the communications manager 1120 may include a reference location manager 1125, a random access resource manager 1130, a random access response manager 1135, a configuration manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The reference location manager 1125 is capable of, configured to, or operable to support a means for outputting a set of reference locations for a set of SSBs to be transmitted to at least one UE, each SSB of the set of SSBs associated with one or more reference locations of the set of reference locations, and each reference location associated with a random access resource of a set of random access resources. The random access resource manager 1130 is capable of, configured to, or operable to support a means for obtaining, from a first UE, a random access message transmitted via a first random access resource of the set of random access resources. The random access response manager 1135 is capable of, configured to, or operable to support a means for outputting one or more response messages to the first UE using a beam associated with a first reference location that corresponds to the first random access resource.

Additionally, or alternatively, the communications manager 1120 may support wireless communications in accordance with examples as disclosed herein. The configuration manager 1140 is capable of, configured to, or operable to support a means for outputting configuration information that indicates a set of reference signal resources for reference signal transmissions to at least one UE, where each reference signal resource of the set of reference signal resources is associated with a random access resource of a set of random access resources. The random access resource manager 1130 is capable of, configured to, or operable to support a means for obtaining, from a first UE, a random access message transmitted via a first random access resource of the set of random access resources. The random access response manager 1135 is capable of, configured to, or operable to support a means for outputting one or more response messages to the first UE, the one or more response messages transmitted using a beam associated with the first random access resource.

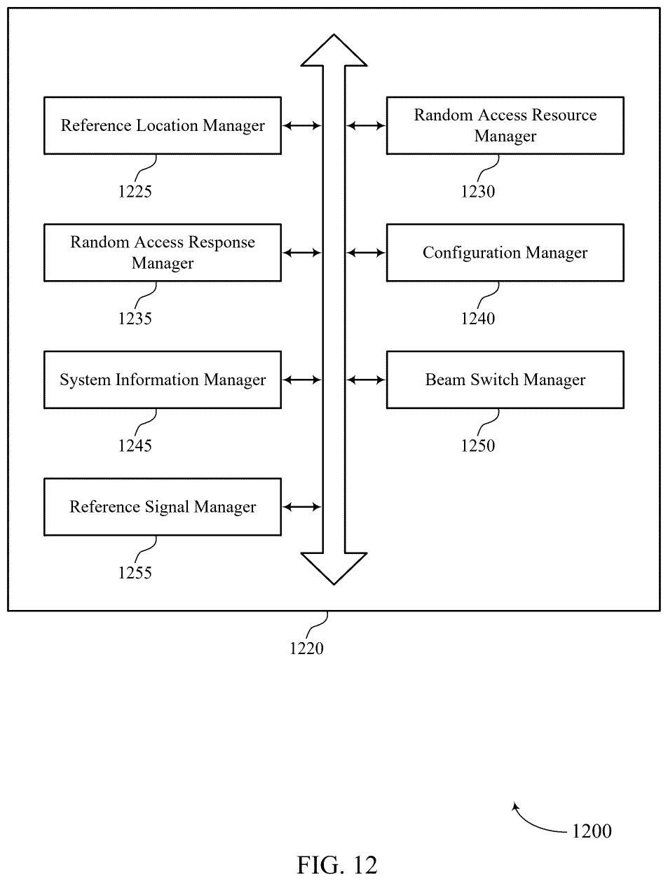

FIG. 12 shows a block diagram 1200 of a communications manager 1220 that supports beam selection techniques for wireless communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of beam selection techniques for wireless communications as described herein. For example, the communications manager 1220 may include a reference location manager 1225, a random access resource manager 1230, a random access response manager 1235, a configuration manager 1240, a system information manager 1245, a beam switch manager 1250, a reference signal manager 1255, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The reference location manager 1225 is capable of, configured to, or operable to support a means for outputting a set of reference locations for a set of SSBs to be transmitted to at least one UE, each SSB of the set of SSBs associated with one or more reference locations of the set of reference locations, and each reference location associated with a random access resource of a set of random access resources. The random access resource manager 1230 is capable of, configured to, or operable to support a means for obtaining, from a first UE, a random access message transmitted via a first random access resource of the set of random access resources. The random access response manager 1235 is capable of, configured to, or operable to support a means for outputting one or more response messages to the first UE using a beam associated with a first reference location that corresponds to the first random access resource.

In some examples, to support outputting the set of reference locations, the system information manager 1245 is capable of, configured to, or operable to support a means for outputting system information that indicates the set of reference locations and associated random access resources. In some examples, the one or more reference locations correspond to GNSS positions, and where each GNSS position is associated with a transmit and receive beam that has a smaller coverage area than a SSB beam used to transmit a SSB associated with a reference location. In some examples, each random access resource of the set of random access resources corresponds to a random access occasion, a random access sequence to be included in an associated random access message, or any combination thereof.

In some examples, one or more SSBs of the set of SSBs are associated with transmit and receive beams having moving coverage areas, and where the first reference location of the UE corresponds to the first reference location based on a time instance associated with the first reference location and ephemeris information associated with the network entity. In some examples, the time instance associated with the first reference location and the ephemeris information associated with the network entity are provided to the first UE in one or more system information blocks.

In some examples, the beam switch manager 1250 is capable of, configured to, or operable to support a means for obtaining, from the first UE, a beam switch request that indicates a first beam for communications with the first UE is to be switched to a second beam, where the first beam corresponds to a first narrow beam associated with the first reference location.

In some examples, the system information manager 1245 is capable of, configured to, or operable to support a means for outputting configuration information that indicates a set of reference signal resources in which an index value of each reference signal resource is associated with a corresponding narrow beam, where the beam switch request indicates a second index value associated with the second beam. In some examples, the set of reference signal resources and associated index values are provided to the first UE in one or more system information blocks. In some examples, the beam switch request indicates one or more channel measurements associated with the second beam meet a measurement threshold value for a configured quantity of measurements or for a configured time period. In some examples, the beam switch request includes an index value of a second reference location among the set of reference locations that is a nearest reference location to a current location of the first UE.

In some examples, the beam switch manager 1250 is capable of, configured to, or operable to support a means for obtaining, from the first UE, a beam change request to switch from a first transmit and receive beam associated with the first reference location to a second transmit and receive beam associated with a second reference location of the set of reference locations, where the beam change request is provided in a MAC-CE or is a random access preamble using a second random access resource associated with the second reference location.

Additionally, or alternatively, the communications manager 1220 may support wireless communications in accordance with examples as disclosed herein. The configuration manager 1240 is capable of, configured to, or operable to support a means for outputting configuration information that indicates a set of reference signal resources for reference signal transmissions to at least one UE, where each reference signal resource of the set of reference signal resources is associated with a random access resource of a set of random access resources. In some examples, the random access resource manager 1230 is capable of, configured to, or operable to support a means for obtaining, from a first UE, a random access message transmitted via a first random access resource of the set of random access resources. In some examples, the random access response manager 1235 is capable of, configured to, or operable to support a means for outputting one or more response messages to the first UE, the one or more response messages transmitted using a beam associated with the first random access resource.

In some examples, to support outputting the configuration information, the reference signal manager 1255 is capable of, configured to, or operable to support a means for outputting, for each port of one or more reference signal resources of the set of reference signal resources, an associated random access resource. In some examples, the first random access resource indicates that one or more measured channel parameters of an associated first reference signal resource meet one or more measurement criteria at the first UE. In some examples, the first random access resource indicates a RSRP of a first reference signal received using an associated first reference signal resource exceeds one or more other RSRP values of one or more other reference signals received using one or more other reference signal resource resources. In some examples, the configuration information indicates a quantity of reference signal instances to be measured by the first UE prior to selection of the first random access resource. In some examples, the first random access resource is further selected based on one or more SSB measurements of a first SSB that is associated with the first random access resource.

In some examples, the beam switch manager 1250 is capable of, configured to, or operable to support a means for obtaining, from the first UE, a beam switch request that indicates a first transmit and receive beam for communications with the UE is to be switched to a second transmit and receive beam, where the first transmit and receive beam corresponds to a first narrow beam associated with a first reference signal resource. In some examples, the configuration information further indicates an index value of each reference signal resource and each reference signal resource is associated with a corresponding narrow beam, and where the beam switch request indicates a second index value associated with the second transmit and receive beam. In some examples, the set of reference signal resources and associated index values are provided in one or more system information blocks. In some examples, the beam switch request indicates one or more channel state information measurements associated with the second transmit and receive beam meet a measurement threshold value for a configured quantity of measurements or for a configured time period.

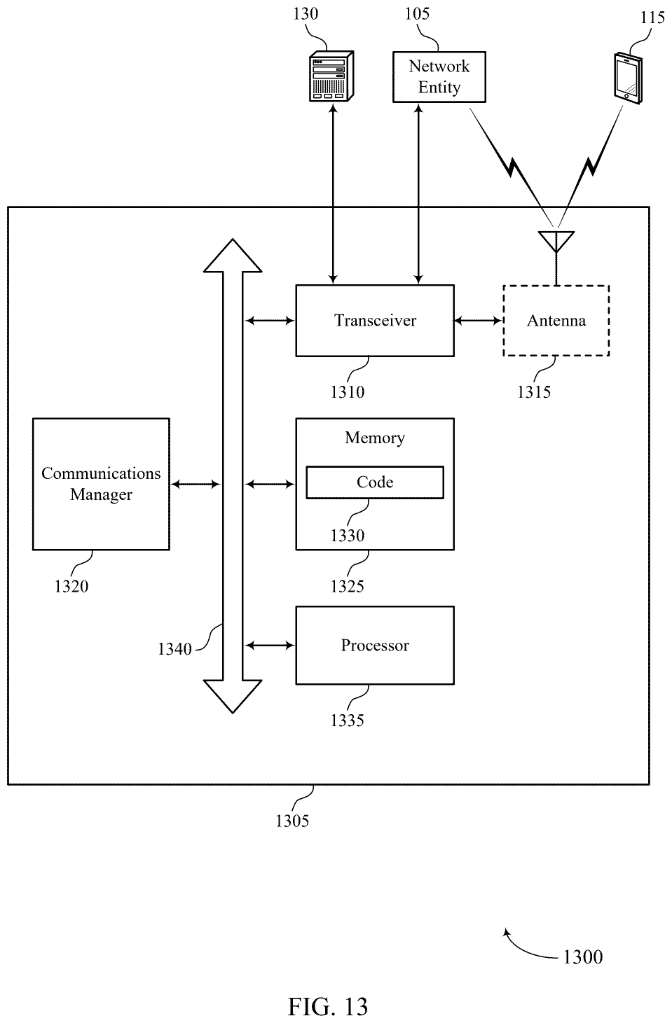

FIG. 13 shows a diagram of a system 1300 including a device 1305 that supports beam selection techniques for wireless communications in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting beam selection techniques for wireless communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a set of reference locations for a set of SSBs to be transmitted to at least one UE, each SSB of the set of SSBs associated with one or more reference locations of the set of reference locations, and each reference location associated with a random access resource of a set of random access resources. The communications manager 1320 is capable of, configured to, or operable to support a means for obtaining, from a first UE, a random access message transmitted via a first random access resource of the set of random access resources. The communications manager 1320 is capable of, configured to, or operable to support a means for outputting one or more response messages to the first UE using a beam associated with a first reference location that corresponds to the first random access resource.

Additionally, or alternatively, the communications manager 1320 may

support wireless communications in accordance with examples as disclosed herein. For example, the communications manager 1320 is capable of, configured to, or operable to support a means for outputting configuration information that indicates a set of reference signal resources for reference signal transmissions to at least one UE, where each reference signal resource of the set of reference signal resources is associated with a random access resource of a set of random access resources. The communications manager 1320 is capable of, configured to, or operable to support a means for obtaining, from a first UE, a random access message transmitted via a first random access resource of the set of random access resources. The communications manager 1320 is capable of, configured to, or operable to support a means for outputting one or more response messages to the first UE, the one or more response messages transmitted using a beam associated with the first random access resource.

By including or configuring the communications manager 1320 in accordance with examples as described herein, the device 1305 may support techniques for narrow beam selection based on signals received at a UE, which may allow for relatively wide coverage SSB transmissions with reduced overhead, and may provide for more efficient communications.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of beam selection techniques for wireless communications as described herein, or the at least one processor 1335 and the at least one memory 1325 may be otherwise configured to, individually or collectively, perform or support such operations.

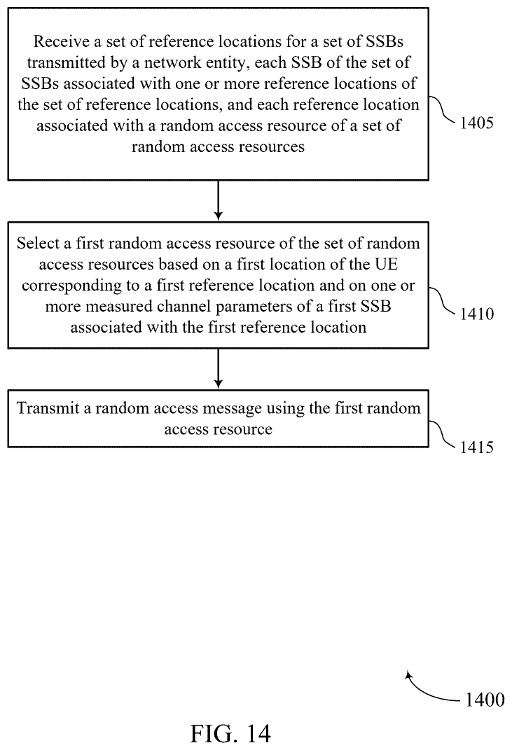

FIG. 14 shows a flowchart illustrating a method 1400 that supports beam selection techniques for wireless communications in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a set of reference locations for a set of SSBs transmitted by a network entity, each SSB of the set of SSBs associated with one or more reference locations of the set of reference locations, and each reference location associated with a random access resource of a set of random access resources. The operations of 1405 may be performed in accordance with examples as disclosed herein. In some examples, aspects of the operations of 1405 may be performed by a reference location manager 825 as described with reference to FIG. 8.

At 1410, the method may include selecting a first random access resource of the set of random access resources based on a first location of the UE corresponding to a first reference location and on one or more measured channel parameters of a first SSB associated with the first reference location. The operations of 1410 may be performed in accordance with examples as disclosed herein. In some examples, aspects of the operations of 1410 may be performed by a random access resource manager 830 as described with reference to FIG. 8.

At 1415, the method may include transmitting a random access message using the first random access resource. The operations of 1415 may be performed in accordance with examples as disclosed herein. In some examples, aspects of the operations of 1415 may be performed by a random access resource manager 830 as described with reference to FIG. 8.

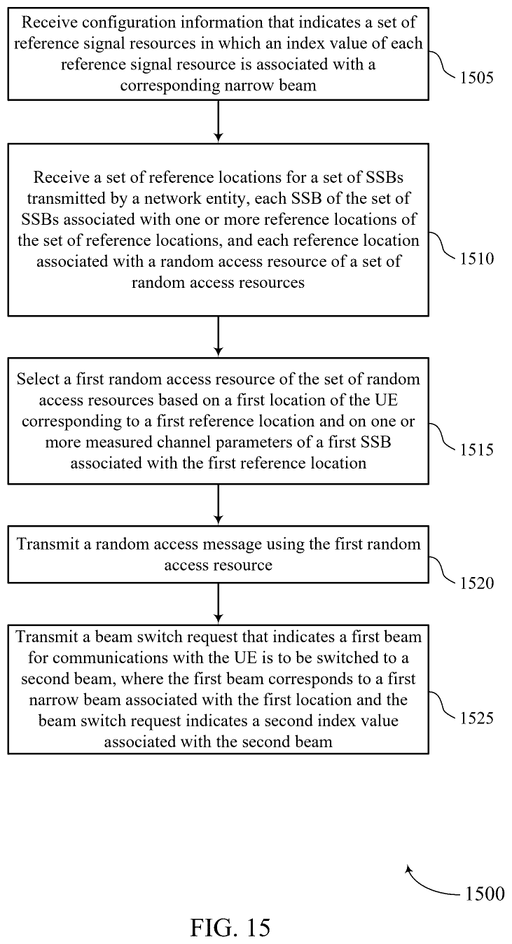

FIG. 15 shows a flowchart illustrating a method 1500 that supports beam selection techniques for wireless communications in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving configuration information that indicates a set of reference signal resources in which an index value of each reference signal resource is associated with a corresponding narrow beam. The operations of 1505 may be performed in accordance with examples as disclosed herein. In some examples, aspects of the operations of 1505 may be performed by a beam switch manager 845 as described with reference to FIG. 8.

At 1510, the method may include receiving a set of reference locations for a set of SSBs transmitted by a network entity, each SSB of the set of SSBs associated with one or more reference locations of the set of reference locations, and each reference location associated with a random access resource of a set of random access resources. The operations of 1510 may be performed in accordance with examples as disclosed herein. In some examples, aspects of the operations of 1510 may be performed by a reference location manager 825 as described with reference to FIG. 8.

At 1515, the method may include selecting a first random access resource of the set of random access resources based on a first location of the UE corresponding to a first reference location and on one or more measured channel parameters of a first SSB associated with the first reference location. The operations of 1515 may be performed in accordance with examples as disclosed herein. In some examples, aspects of the operations of 1515 may be performed by a random access resource manager 830 as described with reference to FIG. 8.

At 1520, the method may include transmitting a random access message using the first random access resource. The operations of 1520 may be performed in accordance with examples as disclosed herein. In some examples, aspects of the operations of 1520 may be performed by a random access resource manager 830 as described with reference to FIG. 8.

At 1525, the method may include transmitting a beam switch request that indicates a first beam for communications with the UE is to be switched to a second beam, where the first beam corresponds to a first narrow beam associated with the first location and the beam switch request indicates a second index value associated with the second beam. The operations of 1525 may be performed in accordance with examples as disclosed herein. In some examples, aspects of the operations of 1525 may be performed by a beam switch manager 845 as described with reference to FIG. 8.

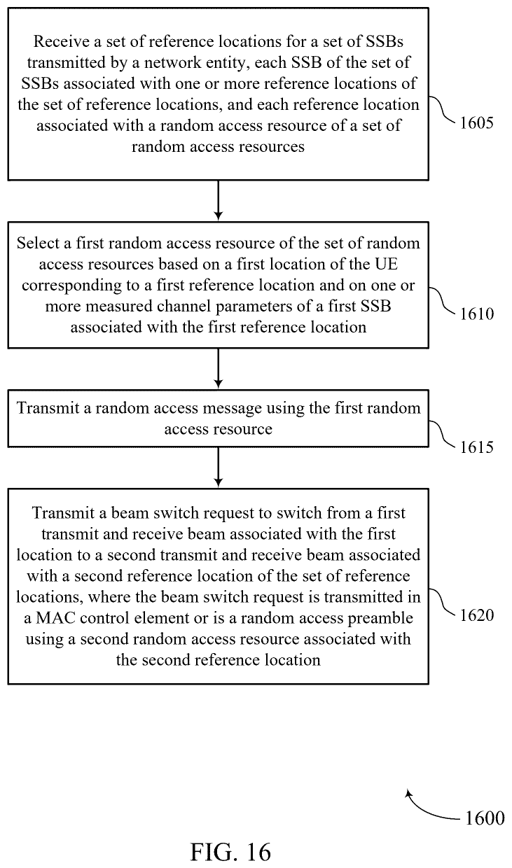

FIG. 16 shows a flowchart illustrating a method 1600 that supports beam selection techniques for wireless communications in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a set of reference locations for a set of SSBs transmitted by a network entity, each SSB of the set of SSBs associated with one or more reference locations of the set of reference locations, and each reference location associated with a random access resource of a set of random access resources. The operations of 1605 may be performed in accordance with examples as disclosed herein. In some examples, aspects of the operations of 1605 may be performed by a reference location manager 825 as described with reference to FIG. 8.

At 1610, the method may include selecting a first random access resource of the set of random access resources based on a first location of the UE corresponding to a first reference location and on one or more measured channel parameters of a first SSB associated with the first reference location. The operations of 1610 may be performed in accordance with examples as disclosed herein. In some examples, aspects of the operations of 1610 may be performed by a random access resource manager 830 as described with reference to FIG. 8.

At 1615, the method may include transmitting a random access message using the first random access resource. The operations of 1615 may be performed in accordance with examples as disclosed herein. In some examples, aspects of the operations of 1615 may be performed by a random access resource manager 830 as described with reference to FIG. 8.

At 1620, the method may include transmitting a beam switch request to switch from a first transmit and receive beam associated with the first location to a second transmit and receive beam associated with a second reference location of the set of reference locations, where the beam switch request is transmitted in a MAC-CE or is a random access preamble using a second random access resource associated with the second reference location. The operations of 1620 may be performed in accordance with examples as disclosed herein. In some examples, aspects of the operations of 1620 may be performed by a beam switch manager 845 as described with reference to FIG. 8.

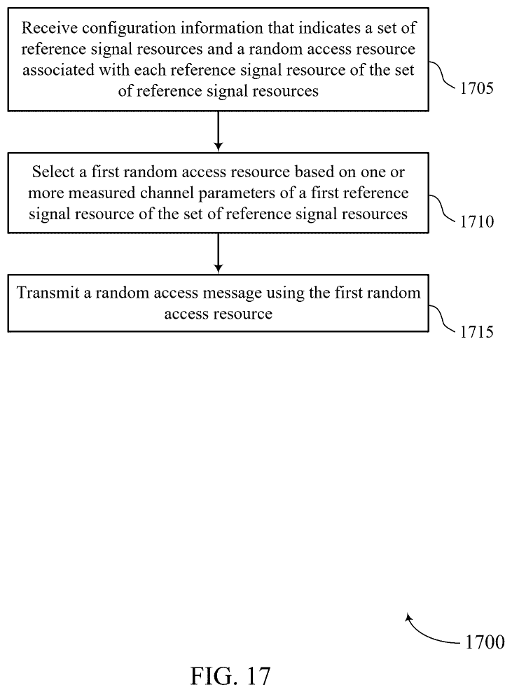

FIG. 17 shows a flowchart illustrating a method 1700 that supports beam selection techniques for wireless communications in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving configuration information that indicates a set of reference signal resources and a random access resource associated with each reference signal resource of the set of reference signal resources. The operations of 1705 may be performed in accordance with examples as disclosed herein. In some examples, aspects of the operations of 1705 may be performed by a configuration manager 835 as described with reference to FIG. 8.

At 1710, the method may include selecting a first random access resource based on one or more measured channel parameters of a first reference signal resource of the set of reference signal resources. The operations of 1710 may be performed in accordance with examples as disclosed herein. In some examples, aspects of the operations of 1710 may be performed by a random access resource manager 830 as described with reference to FIG. 8.

At 1715, the method may include transmitting a random access message using the first random access resource. The operations of 1715 may be performed in accordance with examples as disclosed herein. In some examples, aspects of the operations of 1715 may be performed by a random access resource manager 830 as described with reference to FIG. 8.

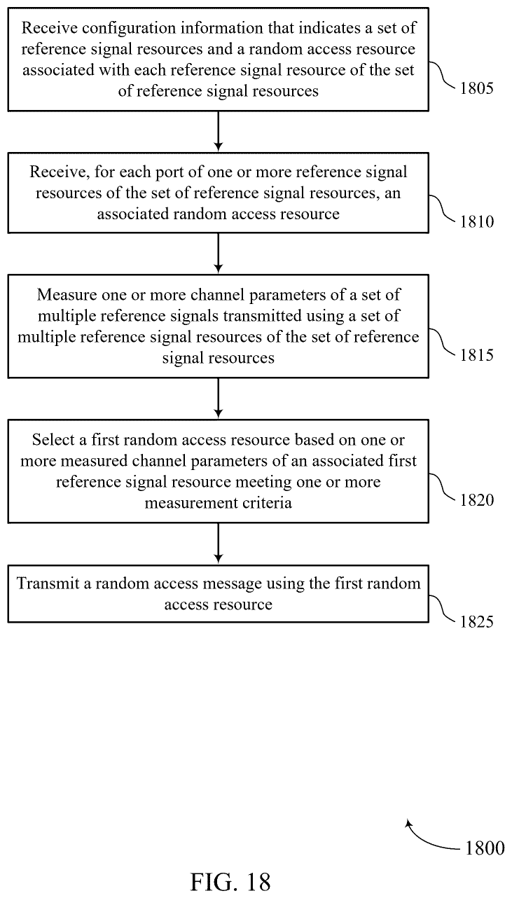

FIG. 18 shows a flowchart illustrating a method 1800 that supports beam selection techniques for wireless communications in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include receiving configuration information that indicates a set of reference signal resources and a random access resource associated with each reference signal resource of the set of reference signal resources. The operations of 1805 may be performed in accordance with examples as disclosed herein. In some examples, aspects of the operations of 1805 may be performed by a configuration manager 835 as described with reference to FIG. 8.

At 1810, the method may include receiving, for each port of one or more reference signal resources of the set of reference signal resources, an associated random access resource. The operations of 1810 may be performed in accordance with examples as disclosed herein. In some examples, aspects of the operations of 1810 may be performed by a random access resource manager 830 as described with reference to FIG. 8.

At 1815, the method may include measuring one or more channel parameters of a set of multiple reference signals transmitted using a set of multiple reference signal resources of the set of reference signal resources. The operations of 1815 may be performed in accordance with examples as disclosed herein. In some examples, aspects of the operations of 1815 may be performed by a measurement manager 850 as described with reference to FIG. 8.

At 1820, the method may include selecting a first random access resource based on one or more measured channel parameters of an associated first reference signal resource meeting one or more measurement criteria. The operations of 1820 may be performed in accordance with examples as disclosed herein. In some examples, aspects of the operations of 1820 may be performed by a measurement manager 850 as described with reference to FIG. 8.

At 1825, the method may include transmitting a random access message using the first random access resource. The operations of 1825 may be performed in accordance with examples as disclosed herein. In some examples, aspects of the operations of 1825 may be performed by a random access resource manager 830 as described with reference to FIG. 8.

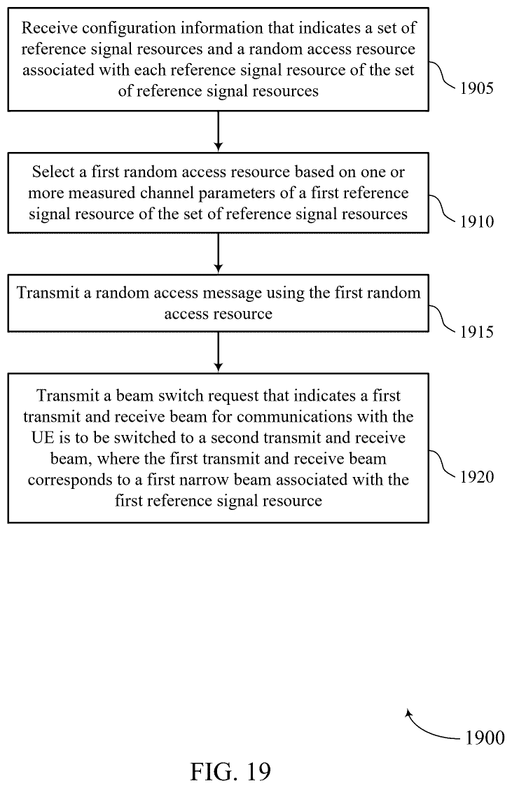

FIG. 19 shows a flowchart illustrating a method 1900 that supports beam selection techniques for wireless communications in accordance with one or more aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may include receiving configuration information that indicates a set of reference signal resources and a random access resource associated with each reference signal resource of the set of reference signal resources. The operations of 1905 may be performed in accordance with examples as disclosed herein. In some examples, aspects of the operations of 1905 may be performed by a configuration manager 835 as described with reference to FIG. 8.

At 1910, the method may include selecting a first random access resource based on one or more measured channel parameters of a first reference signal resource of the set of reference signal resources. The operations of 1910 may be performed in accordance with examples as disclosed herein. In some examples, aspects of the operations of 1910 may be performed by a random access resource manager 830 as described with reference to FIG. 8.

At 1915, the method may include transmitting a random access message using the first random access resource. The operations of 1915 may be performed in accordance with examples as disclosed herein. In some examples, aspects of the operations of 1915 may be performed by a random access resource manager 830 as described with reference to FIG. 8.

At 1920, the method may include transmitting a beam switch request that indicates a first transmit and receive beam for communications with the UE is to be switched to a second transmit and receive beam, where the first transmit and receive beam corresponds to a first narrow beam associated with the first reference signal resource. The operations of 1920 may be performed in accordance with examples as disclosed herein. In some examples, aspects of the operations of 1920 may be performed by a beam switch manager 845 as described with reference to FIG. 8.

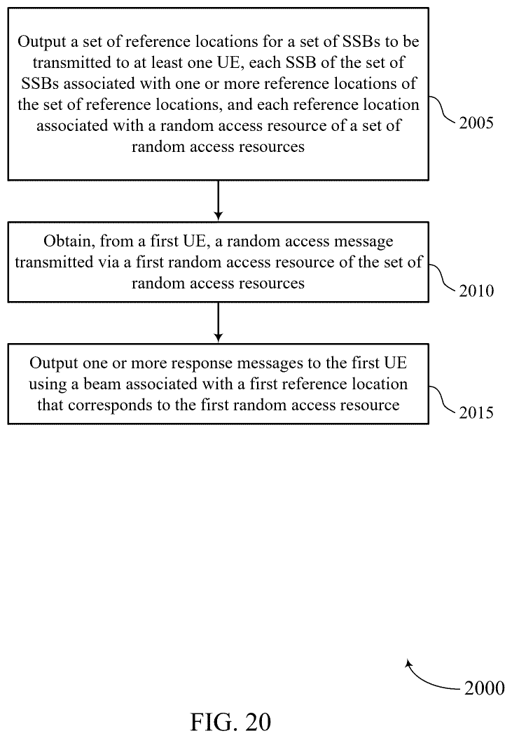

FIG. 20 shows a flowchart illustrating a method 2000 that supports beam selection techniques for wireless communications in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include outputting a set of reference locations for a set of SSBs to be transmitted to at least one UE, each SSB of the set of SSBs associated with one or more reference locations of the set of reference locations, and each reference location associated with a random access resource of a set of random access resources. The operations of 2005 may be performed in accordance with examples as disclosed herein. In some examples, aspects of the operations of 2005 may be performed by a reference location manager 1225 as described with reference to FIG. 12.

At 2010, the method may include obtaining, from a first UE, a random access message transmitted via a first random access resource of the set of random access resources. The operations of 2010 may be performed in accordance with examples as disclosed herein. In some examples, aspects of the operations of 2010 may be performed by a random access resource manager 1230 as described with reference to FIG. 12.

At 2015, the method may include outputting one or more response messages to the first UE using a beam associated with a first reference location that corresponds to the first random access resource. The operations of 2015 may be performed in accordance with examples as disclosed herein. In some examples, aspects of the operations of 2015 may be performed by a random access response manager 1235 as described with reference to FIG. 12.

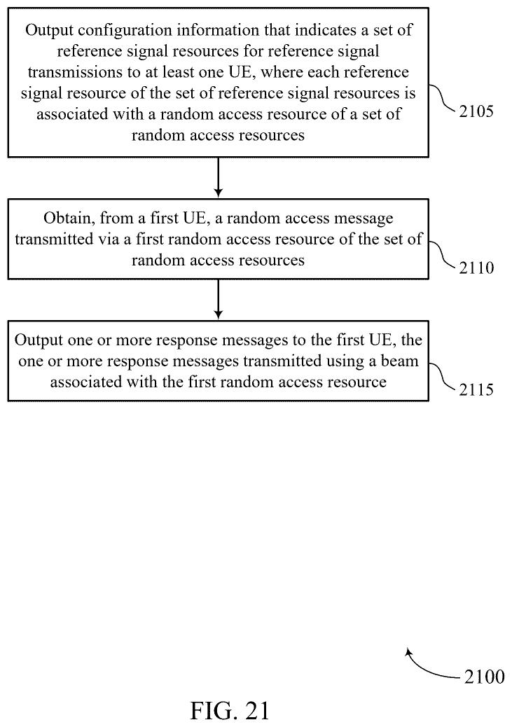

FIG. 21 shows a flowchart illustrating a method 2100 that supports beam selection techniques for wireless communications in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include outputting configuration information that indicates a set of reference signal resources for reference signal transmissions to at least one UE, where each reference signal resource of the set of reference signal resources is associated with a random access resource of a set of random access resources. The operations of 2105 may be performed in accordance with examples as disclosed herein. In some examples, aspects of the operations of 2105 may be performed by a configuration manager 1240 as described with reference to FIG. 12.

At 2110, the method may include obtaining, from a first UE, a random access message transmitted via a first random access resource of the set of random access resources. The operations of 2110 may be performed in accordance with examples as disclosed herein. In some examples, aspects of the operations of 2110 may be performed by a random access resource manager 1230 as described with reference to FIG. 12.

At 2115, the method may include outputting one or more response messages to the first UE, the one or more response messages transmitted using a beam associated with the first random access resource. The operations of 2115 may be performed in accordance with examples as disclosed herein. In some examples, aspects of the operations of 2115 may be performed by a random access response manager 1235 as described with reference to FIG. 12.

The following provides an overview of aspects of the present disclosure:

Aspect 1: A method for wireless communications at a UE, comprising: receiving a set of reference locations for a set of synchronization signal block (SSBs) transmitted by a network entity, each SSB of the set of SSBs associated with one or more reference locations of the set of reference locations, and each reference location associated with a random access resource of a set of random access resources; selecting a first random access resource of the set of random access resources based at least in part on a first location of the UE corresponding to a first reference location and on one or more measured channel parameters of a first SSB associated with the first reference location; and transmitting a random access message using the first random access resource.

Aspect 2: The method of aspect 1, wherein receiving the set of reference locations comprises: receiving system information that indicates the set of reference locations and associated random access resources.

Aspect 3: The method of any of aspects 1 through 2, wherein the one or more reference locations correspond to global navigation satellite system (GNSS) positions, and wherein each GNSS position is associated with a transmit and receive beam that has a smaller coverage area than a SSB beam used to transmit a SSB associated with a reference location.

Aspect 4: The method of any of aspects 1 through 3, wherein each random access resource of the set of random access resources corresponds to a random access occasion, a set of random access sequences to be included in an associated random access message, or any combination thereof.

Aspect 5: The method of any of aspects 1 through 4, wherein one or more SSBs of the set of SSBs are associated with transmit and receive beams having moving coverage areas, and wherein the method further comprises: determining that the first location of the UE corresponds to the first reference location based at least in part on a time instance associated with the first reference location and ephemeris information associated with the network entity.

Aspect 6: The method of aspect 5, wherein the time instance associated with the first reference location is explicitly indicated or pre-defined with reference to a reception time of a system information block that carries the time instance.

Aspect 7: The method of any of aspects 1 through 6, further comprising: transmitting a beam switch request that indicates a first beam for communications with the UE is to be switched to a second beam, wherein the first beam corresponds to a first narrow beam associated with the first location.

Aspect 8: The method of aspect 7, further comprising: receiving configuration information that indicates a set of reference signal resources in which an index value of each reference signal resource is associated with a corresponding narrow beam, wherein the beam switch request indicates a second index value associated with the second beam.

Aspect 9: The method of aspect 8, wherein the set of reference signal resources and associated index values are received in one or more system information blocks.

Aspect 10: The method of any of aspects 7 through 9, wherein the beam switch request is transmitted based at least in part on one or more channel measurements associated with the second beam meeting a measurement threshold value for a configured quantity of measurements or for a configured time period.

Aspect 11: The method of any of aspects 7 through 10, wherein the beam switch request includes an index value of a second reference location among the set of reference locations that is a nearest reference location to a current location of the UE.

Aspect 12: The method of any of aspects 1 through 11, further comprising: transmitting a beam switch request to switch from a first transmit and receive beam associated with the first location to a second transmit and receive beam associated with a second reference location of the set of reference locations, wherein the beam switch request is transmitted in a MAC-CE or is a random access preamble using a second random access resource associated with the second reference location.

Aspect 13: The method of aspect 12, wherein the beam switch request is transmitted based at least in part on a current location of the UE being closer to the second reference location.

Aspect 14: The method of any of aspects 12 through 13, wherein the random access preamble is configured by the network entity.

Aspect 15: A method for wireless communications at a UE, comprising: receiving configuration information that indicates a set of reference signal resources and a random access resource associated with each reference signal resource of the set of reference signal resources; selecting a first random access resource based at least in part on one or more measured channel parameters of a first reference signal resource of the set of reference signal resources; and transmitting a random access message using the first random access resource.

Aspect 16: The method of aspect 15, wherein receiving the configuration information further comprises: receiving, for each port of one or more reference signal resources of the set of reference signal resources, an associated random access resource.

Aspect 17: The method of any of aspects 15 through 16, wherein selecting the first random access resource comprises: measuring one or more channel parameters of a plurality of reference signals transmitted using a plurality of reference signal resources of the set of reference signal resources; and selecting the first random access resource based at least in part on the one or more measured channel parameters of an associated first reference signal resource meeting one or more measurement criteria.

Aspect 18: The method of any of aspects 15 through 17, wherein the first random access resource is selected based at least in part on a reference signal received power (RSRP) of a first reference signal received using the first reference signal resource and one or more other RSRP values of one or more other reference signals received using one or more other reference signal resources.

Aspect 19: The method of any of aspects 15 through 18, wherein the configuration information indicates a quantity of reference signal instances to be measured by the UE prior to selection of the first random access resource.

Aspect 20: The method of any of aspects 15 through 19, wherein the first random access resource is further selected based at least in part on one or more synchronization signal block (SSB) measurements of a first SSB that is associated with the first random access resource.

Aspect 21: The method of any of aspects 15 through 20, further comprising: transmitting a beam switch request that indicates a first transmit and receive beam for communications with the UE is to be switched to a second transmit and receive beam, wherein the first transmit and receive beam corresponds to a first narrow beam associated with the first reference signal resource.

Aspect 22: The method of aspect 21, wherein the configuration information further indicates an index value of each reference signal resource and each reference signal resource is associated with a corresponding narrow beam, and wherein the beam switch request indicates a second index value associated with the second transmit and receive beam.

Aspect 23: The method of aspect 22, wherein the set of reference signal resources and associated index values are received in one or more system information blocks.

Aspect 24: The method of any of aspects 21 through 23, wherein the beam switch request is transmitted based at least in part on one or more measurements associated with the second transmit and receive beam meeting a measurement threshold value for a configured quantity of measurements or for a configured time period.

Aspect 25: A method for wireless communications at a network entity, comprising: outputting a set of reference locations for a set of synchronization signal block (SSBs) to be transmitted to at least one UE, each SSB of the set of SSBs associated with one or more reference locations of the set of reference locations, and each reference location associated with a random access resource of a set of random access resources; obtaining, from a first UE, a random access message transmitted via a first random access resource of the set of random access resources; and outputting one or more response messages to the first UE using a beam associated with a first reference location that corresponds to the first random access resource.

Aspect 26: The method of aspect 25, wherein outputting the set of reference locations comprises: outputting system information that indicates the set of reference locations and associated random access resources.

Aspect 27: The method of any of aspects 25 through 26, wherein the one or more reference locations correspond to global navigation satellite system (GNSS) positions, and wherein each GNSS position is associated with a transmit and receive beam that has a smaller coverage area than a SSB beam used to transmit a SSB associated with a reference location.

Aspect 28: The method of any of aspects 25 through 27, wherein each random access resource of the set of random access resources corresponds to a random access occasion, a random access sequence to be included in an associated random access message, or any combination thereof.

Aspect 29: The method of any of aspects 25 through 28, wherein one or more SSBs of the set of SSBs are associated with transmit and receive beams having moving coverage areas, and wherein the first reference location of the UE corresponds to the first reference location based at least in part on a time instance associated with the first reference location and ephemeris information associated with the network entity.

Aspect 30: The method of aspect 29, wherein the time instance associated with the first reference location and the ephemeris information associated with the network entity are provided to the first UE in one or more system information blocks.

Aspect 31: The method of any of aspects 25 through 30, further comprising: obtaining, from the first UE, a beam switch request that indicates a first beam for communications with the first UE is to be switched to a second beam, wherein the first beam corresponds to a first narrow beam associated with the first reference location.

Aspect 32: The method of aspect 31, further comprising: outputting configuration information that indicates a set of reference signal resources in which an index value of each reference signal resource is associated with a corresponding narrow beam, wherein the beam switch request indicates a second index value associated with the second beam.

Aspect 33: The method of aspect 32, wherein the set of reference signal resources and associated index values are provided to the first UE in one or more system information blocks.

Aspect 34: The method of any of aspects 31 through 33, wherein the beam switch request indicates one or more channel measurements associated with the second beam meet a measurement threshold value for a configured quantity of measurements or for a configured time period.

Aspect 35: The method of any of aspects 31 through 34, wherein the beam switch request includes an index value of a second reference location among the set of reference locations that is a nearest reference location to a current location of the first UE.

Aspect 36: The method of any of aspects 25 through 35, further comprising: obtaining, from the first UE, a beam change request to switch from a first transmit and receive beam associated with the first reference location to a second transmit and receive beam associated with a second reference location of the set of reference locations, wherein the beam change request is provided in a MAC-CE or is a random access preamble using a second random access resource associated with the second reference location.

Aspect 37: A method for wireless communications at a network entity, comprising: outputting configuration information that indicates a set of reference signal resources for reference signal transmissions to at least one UE, wherein each reference signal resource of the set of reference signal resources is associated with a random access resource of a set of random access resources; obtaining, from a first UE, a random access message transmitted via a first random access resource of the set of random access resources; and outputting one or more response messages to the first UE, the one or more response messages transmitted using a beam associated with the first random access resource.

Aspect 38: The method of aspect 37, wherein outputting the configuration information further comprises: outputting, for each port of one or more reference signal resources of the set of reference signal resources, an associated random access resource.

Aspect 39: The method of any of aspects 37 through 38, wherein the first random access resource indicates that one or more measured channel parameters of an associated first reference signal resource meet one or more measurement criteria at the first UE.

Aspect 40: The method of any of aspects 37 through 39, wherein the first random access resource indicates a reference signal received power (RSRP) of a first reference signal received using an associated first reference signal resource exceeds one or more other RSRP values of one or more other reference signals received using one or more other reference signal resource resources.

Aspect 41: The method of any of aspects 37 through 40, wherein the configuration information indicates a quantity of reference signal instances to be measured by the first UE prior to selection of the first random access resource.

Aspect 42: The method of any of aspects 37 through 41, wherein the first random access resource is further selected based at least in part on one or more synchronization signal block (SSB) measurements of a first SSB that is associated with the first random access resource.

Aspect 43: The method of any of aspects 37 through 42, further comprising: obtaining, from the first UE, a beam switch request that indicates a first transmit and receive beam for communications with the UE is to be switched to a second transmit and receive beam, wherein the first transmit and receive beam corresponds to a first narrow beam associated with a first reference signal resource.

Aspect 44: The method of aspect 43, wherein the configuration information further indicates an index value of each reference signal resource and each reference signal resource is associated with a corresponding narrow beam, and wherein the beam switch request indicates a second index value associated with the second transmit and receive beam.

Aspect 45: The method of aspect 44, wherein the set of reference signal resources and associated index values are provided in one or more system information blocks.

Aspect 46: The method of any of aspects 43 through 45, wherein the beam switch request indicates one or more channel state information measurements associated with the second transmit and receive beam meet a measurement threshold value for a configured quantity of measurements or for a configured time period.

Aspect 47: A UE for wireless communications, comprising one or more memories storing processor-executable code, and one or more processors coupled with the one or more memories and individually or collectively operable to execute the code to cause the UE to perform a method of any of aspects 1 through 14.

Aspect 48: A UE for wireless communications, comprising at least one means for performing a method of any of aspects 1 through 14.

Aspect 49: A non-transitory computer-readable medium storing code for wireless communications, the code comprising instructions executable by one or more processors to perform a method of any of aspects 1 through 14.

Aspect 50: A UE for wireless communications, comprising one or more memories storing processor-executable code, and one or more processors coupled with the one or more memories and individually or collectively operable to execute the code to cause the UE to perform a method of any of aspects 15 through 24.

Aspect 51: A UE for wireless communications, comprising at least one means for performing a method of any of aspects 15 through 24.

Aspect 52: A non-transitory computer-readable medium storing code for wireless communications, the code comprising instructions executable by one or more processors to perform a method of any of aspects 15 through 24.

Aspect 53: A network entity for wireless communications, comprising one or more memories storing processor-executable code, and one or more processors coupled with the one or more memories and individually or collectively operable to execute the code to cause the network entity to perform a method of any of aspects 25 through 36.

Aspect 54: A network entity for wireless communications, comprising at least one means for performing a method of any of aspects 25 through 36.

Aspect 55: A non-transitory computer-readable medium storing code for wireless communications, the code comprising instructions executable by one or more processors to perform a method of any of aspects 25 through 36.

Aspect 56: A network entity for wireless communications, comprising one or more memories storing processor-executable code, and one or more processors coupled with the one or more memories and individually or collectively operable to execute the code to cause the network entity to perform a method of any of aspects 37 through 46.

Aspect 57: A network entity for wireless communications, comprising at least one means for performing a method of any of aspects 37 through 46.

Aspect 58: A non-transitory computer-readable medium storing code for wireless communications, the code comprising instructions executable by one or more processors to perform a method of any of aspects 37 through 46.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a set of reference locations for a set of synchronization signal blocks (SSBs) transmitted by a network entity, each SSB of the set of SSBs associated with one or more reference locations of the set of reference locations, and each reference location associated with a random access resource of a set of random access resources;
select a first random access resource of the set of random access resources based at least in part on a first location of the UE corresponding to a first reference location and on one or more measured channel parameters of a first SSB associated with the first reference location; and
transmit a random access message using the first random access resource.

2. The UE of claim 1, wherein, to receive the set of reference locations, the one or more processors are individually or collectively operable to execute the code to cause the UE to:
receive system information that indicates the set of reference locations and associated random access resources.

3. The UE of claim 1, wherein the one or more reference locations correspond to global navigation satellite system (GNSS) positions, and wherein each GNSS position is associated with a transmit and receive beam that has a smaller coverage area than a SSB beam used to transmit a SSB associated with a reference location.

4. The UE of claim 1, wherein each random access resource of the set of random access resources corresponds to a random access occasion, a set of random access sequences to be included in an associated random access message, or any combination thereof.

5. The UE of claim 1, wherein one or more SSBs of the set of SSBs are associated with transmit and receive beams having moving coverage areas, and the one or more processors are individually or collectively further operable to execute the code to cause the UE to:
determine that the first location of the UE corresponds to the first reference location based at least in part on a time instance associated with the first reference location and ephemeris information associated with the network entity.

6. The UE of claim 5, wherein the time instance associated with the first reference location is explicitly indicated or pre-defined with reference to a reception time of a system information block that carries the time instance.

7. The UE of claim 1, wherein the one or more processors are individually or collectively further operable to execute the code to cause the UE to:
transmit a beam switch request that indicates a first beam for communications with the UE is to be switched to a second beam, wherein the first beam corresponds to a first narrow beam associated with the first location.

8. The UE of claim 7, wherein the one or more processors are individually or collectively further operable to execute the code to cause the UE to:
receive configuration information that indicates a set of reference signal resources in which an index value of each reference signal resource is associated with a corresponding narrow beam, wherein the beam switch request indicates a second index value associated with the second beam.

9. The UE of claim 8, wherein:
the set of reference signal resources and associated index values are received in one or more system information blocks.

10. The UE of claim 7, wherein the beam switch request is transmitted based at least in part on one or more channel measurements associated with the second beam meeting a measurement threshold value for a configured quantity of measurements or for a configured time period.

11. The UE of claim 7, wherein the beam switch request includes an index value of a second reference location among the set of reference locations that is a nearest reference location to a current location of the UE.

12. The UE of claim 1, wherein the one or more processors are individually or collectively further operable to execute the code to cause the UE to:
transmit a beam switch request to switch from a first transmit and receive beam associated with the first location to a second transmit and receive beam associated with a second reference location of the set of reference locations, wherein the beam switch request is transmitted in a medium access control (MAC) control element or is a random access preamble using a second random access resource associated with the second reference location.

13. The UE of claim 12, wherein the beam switch request is transmitted based at least in part on a current location of the UE being closer to the second reference location.

14. A user equipment (UE), comprising:
one or more memories storing processor-executable code; and
one or more processors coupled with the one or more memories and individually or collectively operable to execute the code to cause the UE to:
receive configuration information that indicates a set of reference signal resources and a random access resource associated with each reference signal resource of the set of reference signal resources;
select a first random access resource based at least in part on one or more measured channel parameters of a first reference signal resource of the set of reference signal resources; and
transmit a random access message using the first random access resource.

15. The UE of claim 14, wherein, to receive the configuration information, the one or more processors are individually or collectively further operable to execute the code to cause the UE to:
receive, for each port of one or more reference signal resources of the set of reference signal resources, an associated random access resource.

16. The UE of claim 14, wherein, to select the first random access resource, the one or more processors are individually or collectively operable to execute the code to cause the UE to:
measure one or more channel parameters of a plurality of reference signals transmitted using a plurality of reference signal resources of the set of reference signal resources; and
select the first random access resource based at least in part on the one or more measured channel parameters of an associated first reference signal resource meeting one or more measurement criteria.

17. The UE of claim 14, wherein the one or more processors are individually or collectively further operable to execute the code to cause the UE to:
transmit a beam switch request that indicates a first transmit and receive beam for communications with the UE is to be switched to a second transmit and receive beam, wherein the first transmit and receive beam corresponds to a first narrow beam associated with the first reference signal resource.

18. A method for wireless communications at a user equipment (UE), comprising:
receiving a set of reference locations for a set of synchronization signal blocks (SSBs) transmitted by a network entity, each SSB of the set of SSBs associated with one or more reference locations of the set of reference locations, and each reference location associated with a random access resource of a set of random access resources;
selecting a first random access resource of the set of random access resources based at least in part on a first location of the UE corresponding to a first reference location and on one or more measured channel parameters of a first SSB associated with the first reference location; and
transmitting a random access message using the first random access resource.

19. The method of claim 18, wherein receiving the set of reference locations comprises:
receiving system information that indicates the set of reference locations and associated random access resources.

20. The method of claim 18, wherein the one or more reference locations correspond to global navigation satellite system (GNSS) positions, and wherein each GNSS position is associated with a transmit and receive beam that has a smaller coverage area than a SSB beam used to transmit a SSB associated with a reference location.
